(19) United States
(12) Patent Application Publication
(10) Pub. No.: US 2023/0372956 A1
(43) Pub. Date: Nov. 23, 2023

(54) SPRAYER DIAGNOSTIC AND REMEDIAL SYSTEM AND METHODS FOR SAME

(71) Applicant: Raven Industries, Inc., Sioux Falls, SD (US)

(72) Inventors: Jared Ernest Kocer, Sioux Falls, SD (US); Parag Garg, Sioux Falls, SD (US)

(21) Appl. No.: 18/319,386

(22) Filed: May 17, 2023

Related U.S. Application Data
(60) Provisional application No. 63/342,973, filed on May 17, 2022.

(51) Int. Cl. B05B 12/00; B05B 1/20; B05B 12/08; B05B 12/12

(52) U.S. Cl. CPC B05B 12/004; B05B 1/20; B05B 12/082; B05B 12/124; A01M 7/0042

(57) ABSTRACT

An automated sprayer diagnostic system includes at least one sensor directed toward at least one nozzle assembly of a sprayer implement. A sprayer diagnostic controller is in communication with the at least one sensor. The sprayer diagnostic controller includes a performance deviation comparator configured to compare the sensed actual performance profile of the at least one nozzle assembly with a specified performance profile and determine one or more performance deviations from the comparison. A performance issue diagnostic module is configured to identify at least one performance issued based on the one or more performance deviations. A diagnostic indication module is configured to provide a diagnostic indication of the identified at least one performance issue.

### CLAIM OF PRIORITY AND INCORPORATION BY REFERENCE

This patent application claims the benefit under 35 U.S.C. § 119(e) of U.S. Provisional Patent Application 63/342,973, filed May 17, 2022, the disclosure of which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc. of Sioux Falls, South Dakota, USA. All Rights Reserved.

### TECHNICAL FIELD

This document pertains generally, but not by way of limitation, to agricultural vehicle and implements including, but not limited to, agricultural sprayers.

### BACKGROUND

Agricultural vehicles and implements includes a variety of systems configured to conduct one or more agricultural operations. Agricultural operations include, but are not limited to, tilling, planting, spraying, cultivation, harvesting, collection of harvested crops and transporting harvested crops.

Agricultural sprayers are example vehicles and vehicle-drawn implements that conduct spraying operations. Sprayers include one or more sprayer booms that extend from the vehicle or pulled implement. The sprayer booms include one or more boom sections, such as left, right and central sections. Each of the sections include a plurality of nozzle assemblies configured to spray agricultural product along crop rows. For instance, agricultural product is sprayed toward crops, weeds, ground, pests or the like. In some examples, dozens or even hundreds of nozzle assemblies are provided along the sprayer booms. Each of the nozzle assemblies is in communication with at least one agricultural product reservoir with intervening pumps, tubing or the like. In other examples, a carrier fluid reservoir and one or more separate injection product reservoirs are in communication with the nozzle assemblies. The nozzle assemblies or upstream locations from the nozzle assemblies locally inject the injection product to the carrier fluid to control one or both of composition and concentration of the injection product (or products) in the carrier fluid.

The nozzle assemblies are adjusted by operators based on operator knowledge of the target crop, pests or weeds present in the field, understanding of crop health within a field, present weather conditions (e.g., wind speed and direction, precipitation, temperature or the like), characteristics of the agricultural product (optionally the injection product(s)), manufacturer specified prescriptions for the application of the agricultural product or the like. The nozzle assemblies are in various examples adjusted to control one or more nozzle characteristics including droplet size, spray pattern (e.g., arc, arc orientation or the like).

### SUMMARY

The present inventors have recognized, among other things, that a problem to be solved can include monitoring operations of an agricultural vehicle, agricultural implement or both, automatically diagnosing one or more performance issues, and optionally automatically relaying remedial actions or automatically conducting remedial actions.

Agricultural vehicles, implements or the like, such as agricultural sprayers, have numerous interconnected systems that cooperatively control the flow rate, pressure, droplet sizes, spray patterns or the like of sprayed agricultural product from plural nozzle assemblies of the sprayers. The nozzle assemblies generate actual spray patterns with associated performance characteristics (e.g., an actual performance profile), and in some examples, maintenance issues, broken or failing components, specified variations in performance between nozzle assemblies, and the complexity of agricultural sprayers (collectively, performance issues) cause deviations of an actual performance profile relative to a specified performance profile (e.g., flow rate, spray pattern, droplet size, plumbing characteristics, boom height or the like). The potential causes for variations in performance from a specified performance profile are numerous, with some causes interrelated, others unrelated, or the like.

In some examples, operators (e.g., farmers, technicians, OEM personnel or the like) have extensive training and accumulated knowledge of agricultural vehicles and implements, and with examination of the agricultural vehicle or implement, are able to identify performance issues and provide remedial actions to address the performance issues. For instance, trained operators observe sprayer performance in the field, initiate spraying at a standstill with water, or the like to examine sprayer performance. Through observation of sprayer performance the trained operator determines performance issues and related remedial actions that may be taken to address the performance issues.

The extensive training and accumulated knowledge facilitate identification of performance issues by trained operators. In contrast, it is difficult to automatically perform diagnostic analysis. An example sprayer vehicle or implement includes numerous interconnected systems that may affect the actual performance profile of each nozzle assembly. For instance, plumbing extends between reservoirs and nozzle assemblies including tubes, manifolds, control valves, pumps, flow meters or the like; control elements (e.g., valves, pumps or the like) are operated electronically with actuators, pulse width modulation control or the like and at times have varied performance between nozzle assemblies; spray tips are operable (manually or automatically) to control droplet size, spray pattern (e.g., arc, orientation of the arc or the like). Further, in some examples, the actual performance profile and the specified performance profile of each nozzle may vary (e.g., based on boom location, the associated target or zone of coverage for the nozzle assembly or the like) providing multiplicative variations in performance based on the number of observed nozzle assemblies and associated actual performance profiles that are above and beyond those caused by performance issues with plumbing, control elements or the like. Accordingly, observation of all or at least multiple nozzle assemblies and the automated diagnosis of performance issues is a laborious task to automate because of the complexity of the systems of the agricultural vehicle or implement.

The present subject matter can help provide a solution to this problem, for instance with a system that monitors the performance of an agricultural vehicle or implement conducting an agricultural operation and determines deviations between actual performance characteristics (e.g., actual performance profiles) of nozzle assemblies relative to specified performance characteristics (e.g., specified performance profiles). The system compares the determined deviations with catalogued performance issues having the associated deviations, such as similar or identical deviations by type, magnitude or the like to the determined deviations from the synthesized determined deviations. In one example, the system implements one or more diagnostic schemes to assess the actual performance profile of one or more nozzle assemblies relative to a specified performance profile to identify performance issues. Optionally, the diagnostic schemes are conducted with a carrier fluid, such as water, to conserve agricultural product and minimize environmental influence. In another example, the diagnostic scheme is conducted before conducting an agricultural operation in field. Optionally, the diagnostic scheme is conducted while conducting the agricultural operation, for instance while turning between swaths.

For example, an example sprayer diagnostic controller initiates a diagnostic scheme including pressurization of the sprayer implement and controlled operation of one or more nozzle assemblies, associated plumbing, and associated control features (e.g., pumps, valves or the like). The system includes one or more sensors to monitor at least nozzle assembly performance during implementation of the diagnostic scheme. A performance deviation comparator of the controller determines performance deviations of the nozzle assembly (and optionally proximate portions of the implement, like tubing) performance relative to a specified performance profile including one or more specified performance thresholds (e.g., droplet characteristics, such as size; droplet modulation; pattern locality; spray origin or the like). The sprayer diagnostic controller is in communication with a performance issue catalog having a plurality of logged performance issues, for instance at least first and second performance issues (e.g., droplet size error, nozzle position error, nozzle plugging, plumbing leak or the like). Each of the catalogued performance issues includes associated arrays of threshold deviations for comparison with the determined performance deviations.

A performance issue diagnostic module conducts an array comparison of the one or more performance deviations collected from actual performance at or proximate to the nozzle assembly with the first and second threshold arrays (of threshold deviations) of the first and second performance issues. The performance issue diagnostic module selects at least one of the catalogued performance issues based on the array comparison. A performance issue that includes an array of threshold deviations (e.g., one or more) corresponding to the determined performance deviations is selected by the performance issue diagnostic module. In some examples, with multiple corresponding performance issues multiple selections are made and indicated. For example, the module selects a first performance issue if a first difference between the performance deviations and the threshold deviations of the first threshold array are less than a difference between a second difference between the performance deviations and the second threshold array threshold deviations. The smaller difference is indicative of the actual performance better comporting to the first performance issue. In another example, if the first and second differences are nominally different (e.g., 1, 5 or 10 percent varied or the like) both performance issues are selected and indicated.

The sprayer diagnostic controller includes a diagnostic indication module configured to provide diagnostic indications, such as text based notifications, visual notifications, messages or the like that describe the selected performance issue. Optionally, the performance issue catalog includes suggested remedial actions (RA) that are associated with the catalogued performance issues. In such an example, the diagnostic indications also include the suggested remedial actions including, but not limited to, adjustment of a nozzle, repair of plumbing, or the like.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of an agricultural vehicle and agricultural implement having an automated sprayer diagnostic system.

FIG. 2 is a schematic top view of another example of an agricultural vehicle and agricultural implement with sensors oriented toward the implement output.

FIG. 3 is a schematic view of an example nozzle assembly having a specified spray profile.

FIG. 4A is a schematic view of one example of a droplet threshold and a schematic view of another example of a droplet threshold.

FIG. 4B is a schematic view of one example of a spray pattern arc threshold.

FIG. 4C is a schematic view of example performance issues including nozzle orientation, pattern orientation, pattern arc, nozzle plugging or fouling and plumbing leaking issues.

FIG. 4D is a schematic view of example performance issues including nozzle positioning and monitored performance characteristics.

FIG. 5A-5D are diagrams illustrating example performance issues and monitored performance characteristics.

FIG. 6A is an example user interface configured for control of an agricultural implement and initiation of a diagnostic scheme.

FIG. 6B is an example diagnostic report generated with an automated sprayer diagnostic system.

FIG. 7A is a first schematic view of an example diagnostic operation conducted across multiple nozzle assemblies of FIGS. 6A and 6B.

FIG. 7B is a second schematic view of the diagnostic operation of FIGS. 6A and 6B.

FIG. 7C is a third schematic view of the diagnostic operation of FIGS. 6A and 6B.

### DETAILED DESCRIPTION

In agricultural operations, systems, components, tools or vehicles are used individually or in combination for conducting agricultural operations in a field. For example, agricultural operations include, but are not limited to, spraying, spreading, harvesting, gathering, planting, mowing, cutting, tilling, cultivating, baling or the like. In some examples, sprayers prepare or treat a field or crops in a field. Sprayers are agricultural vehicles, or separate implements coupled with a tractor or the like, that include one or more sprayer booms extending from the vehicle or pulled implement. The sprayer booms including plumbing and a plurality of spray nozzles for application of agricultural products in a field, for instance to the soil, crops, pests, weeds or the like.

The one or more sprayer booms optionally include one or more boom sections, such as left, right and central sections. In some examples, sprayer booms include plumbing extending along the one or more sections that transfer agricultural fluid (e.g., water, carrier fluid, mixtures of water and carrier fluid, or the like) from a reservoir (e.g., tank, container, cartridge, or the like) to at least one nozzle assembly (a fluid dispense mechanism). In an example, the at least one nozzle assembly is provided along the sprayer booms or sprayer boom sections and the nozzle assembly is in communication with the reservoir via intervening pumps, tubing or the like. Each nozzle assembly has an orifice, or opening, that dispenses or distributes, as a spray, the agricultural fluid transferred from the reservoir out to targets (e.g., crop, portions of crops such as foliage, weeds, pests, soil or the like). For example, each nozzle assembly sprays agricultural fluid particles (e.g., droplets) having a specified size (including range of sizes) in a specified spray pattern towards targets.

The one or more nozzle assemblies generate spray patterns (e.g., the spray pattern actually dispensed from the one or more nozzle assembly) with associated performance characteristics (e.g., a performance profile). In some examples, maintenance issues, broken or failing components, specified variations in performance between nozzle assemblies, and the complexity of agricultural sprayers (collectively, performance issues), alone or in combination, cause deviations of the (actual) performance profile relative to a specified performance profile (e.g., flow rate, spray pattern, droplet size or the like). The potential causes for variations in performance from a specified performance profile are numerous, with some causes interrelated, others unrelated, or the like. In an example, the actual spray profiles of one or more nozzle assemblies are monitored or observed by one or more sensors provided along the boom or boom section at locations associated with the nozzle assemblies. The one or more sensors communicate with a computerized diagnostic system described herein. In an example, the diagnostic system indicates to a user the presence of faults (e.g., failures or irregularities) with the components of an agricultural vehicle, such as faults with the spray dispensed from at least one nozzle. In another example, the diagnostic system recommends one or more remedial actions to address the detected faults. In still another example, the diagnostic system selects and implements one or more remedial actions to address the detected faults.

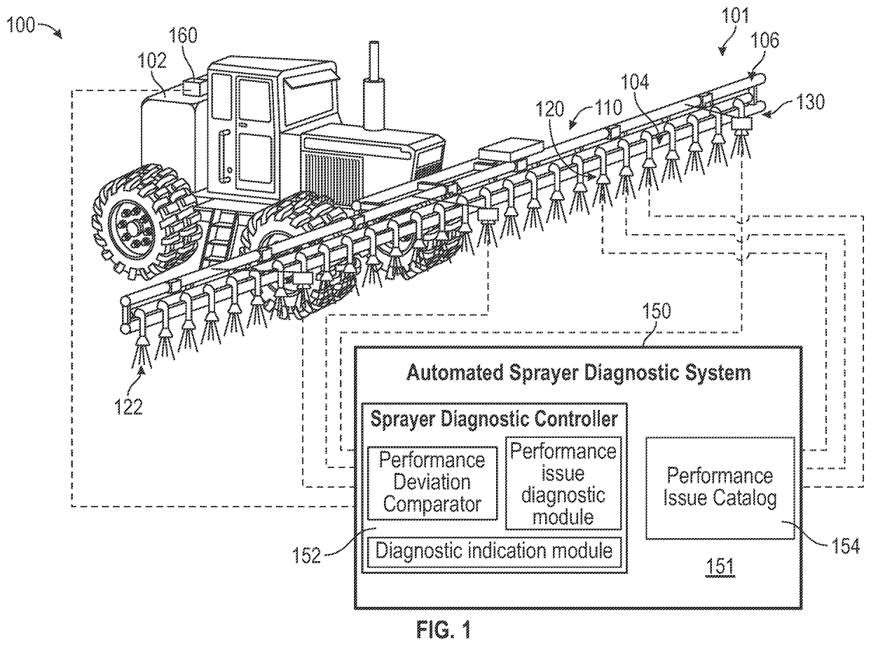

An example of agricultural vehicle such as a sprayer 100 is illustrated in FIG. 1 an. In other examples, the agricultural vehicle includes, but is not limited to, vehicles and associated implements (e.g., included with the vehicle or towed) such as tillers, planters, seeders, cultivators, combines, mowers, balers, spreaders or the like may experience performance issues associated with conduct of agricultural operations, for instance because of issues with components of the implements, vehicles or the like. A sprayer is described herein, but the present document is not limited to sprayers. Instead, agricultural vehicles, implements or the like similarly benefit from diagnostic systems that identify performance issues and provided one or more of indications, remedial actions or the like to address performance issues.

The exemplary sprayer 100 illustrated in FIG. 1 includes plumbing such as a boom tube 104 provided along a sprayer boom 106. The boom tube 104 is in communication with at least one reservoir 102 and with operational components, such as at least one nozzle assembly 120. In another example, the reservoir 102 includes a plurality of reservoirs with each reservoir containing a different fluid. For instance, a first reservoir includes a carrier fluid, such as water or a base agricultural product (water premixed with an additive) and another reservoir contains a herbicide, pesticide, fertilizer or the like. In an example, the at least one nozzle assembly 120 dispenses an agricultural product including at least one fluid, or a mixture of fluids (e.g., water, one or more additives or the like).

The example sprayer 100 has at least one nozzle assembly 120 coupled with the sprayer boom 106. In another example, there are multiple nozzle assemblies 120 provided along the sprayer boom 106, for instance with spacing therebetween such as longitudinally along length of the sprayer boom 106 or spaced one in front of the other. Optionally, the at least one nozzle assembly 120 includes one or more proximate components of the implement, such as portions of the boom tube 104 adjacent to the nozzle assembly 120, plumbing components (e.g., valves or the like), or instruments (pressure transducers, flow meters, camera to view the spray pattern). In an example, the at least one nozzle assembly 120 dispenses agricultural fluid in a spray pattern 122. The spray pattern 122 is, for example, a way of dispensing agricultural fluid toward agricultural products according to type of agricultural product or accounting for environmental conditions (e.g., wind, temperature, field profile, or the like).

In an example, a sensor 130 associated with at least one nozzle assembly 120 monitors the dispensed spray pattern 122. In an example the sensor 130 is coupled with the sprayer boom 106. In another example, the sensor 130 is remotely coupled with a drone, separate vehicle or the like, and is remotely coupled with the remainder of the system 150, for instance wirelessly. In one example, the sensor 130 is directed toward at least one nozzle assembly 120 of the sprayer implement 110 and monitors (e.g., observes or senses) the spray pattern 122 for the nozzle assembly 120. In other examples, the sensor 130 is directed toward a plurality of nozzle assemblies 120 and correspondingly monitors (e.g., observes or senses) spray patterns 122 of the plurality of nozzle assemblies. In still other examples, the sensor 130 is directed toward varying components of the implement, such as the sprayer 100, including plumbing, pumps, valves, nozzle assemblies or the like. The sensor 130 (including one or more sensors 130) correspondingly monitors (e.g., observes or senses) the performance of the sprayer system 101 including one or more of these components. In an example, the sensor 130 provides (recursively or at specific times) data related to sensor observations to an automated sprayer diagnostic system 150.

The automated sprayer diagnostic system 150 described herein cooperates with sensors 130 to observe implement performance, identify performance issues, and optionally conduct one or more of remedial action selection or implementation. The system 150 shown in FIG. 1, is in one example a component of the operation system 160 of the sprayer 100. In another example the automated sprayer diagnostic system 150 is a separate component that is physically wired or wirelessly connected with the operation system 160. In yet another example, the automated sprayer diagnostic system 150 a virtual system that is cloud based and accessed by way of a wireless connection between the vehicle and the system (e.g., cellular, wifi, satellite or the like). As further discussed herein, the automated sprayer diagnostic system 150 assesses monitoring conducted by the one or more sensors 130 and identifies performance issues. In some examples, the diagnostic system 150 implements one or more diagnostic schemes including, but not limited to, pressurizing the sprayer system 101, selectively operating one or more nozzle assemblies 120, the plumbing associated with spraying or the like to permit observation of the sprayer and identification of performance issues. In other example, the diagnostic system diagnoses performance issues while the sprayer 100 conducts agricultural operations.

The automated sprayer diagnostic system 150 shown in FIG. 1 includes a processor having at least one memory component, logic and associated programing and instructions that provide a performance issue catalog 154 and a sprayer diagnostic controller 152 to analyze the data from the one or more sensors 130. The performance issue catalog 154 includes, performance issues (e.g., abnormalities, faults, failures or the like) related to the operation of the sprayer 100 including the one or more nozzle assemblies 120, plumbing, valves, pumps, or the like as well as the sprayed agricultural product. In an example, the sprayer diagnostic controller 152 provides notifications of identified performance issues. In another example, the sprayer diagnostic controller 152 selects and indicates remedial actions for resolving (fixing, circumventing, working around, or the like) the performance issue of the sprayer 100. In still other examples, the sprayer diagnostic controller 152 implements remedial actions autonomously to address identified performance issues, as described herein.

The performance issue catalog 154 optionally has a library of performance issues that may occur during operation or the conduct of diagnostic schemes. The performance issue catalog 154 includes nozzle performance characteristics, specified performance thresholds or the like associated with library performance issues. In an example, the performance issue catalog 154 indexes (e.g., records, tracks, logs or the like) performance issues and associated nozzle performance characteristics and performance thresholds. For example, the performance issue catalog 154 includes one or more stored performance issues, and each of the performance issues includes one or more associated performance characteristics, deviations of performance characteristics relative to a specified performance profile or the like that are indicative of the respective performance issue. As described herein, the monitored performance characteristics, deviations of those characteristics relative to a specified performance profile for sprayer operation or the like detected with one or more sensors are assessed against the indexed performance issues and the respective characteristics and deviations of those issues. Correspondence of the monitored performance characteristics, deviations or the like with the performance characteristics, deviations or similar of one or more performance issues is indicative of the performance issue (or issues). In some example performance issues occur with one or more nozzle performance characteristics (including zones proximate to the nozzles) and associated performance deviations such as the location of the at least one nozzle assembly 120 or the spray characteristics distributed from the at least one nozzle assembly 120. Example performance issues for the sprayer 100 include, but are not limited to performance issues related to the spray profile, nozzle assembly or the plumbing. For example, the sensor 130 monitors droplet size dispensed from the nozzle assembly and transmits data related to the droplet size. The data includes, for example, indications of a deviations from a specified droplet size or profile. In another example, the sensor monitors the spray pattern emitted from a nozzle tip. The automated sprayer diagnostic system 150 via a processor 151, processes the information transmitted from the sensors 130 and after comparison with the data in the performance issue catalog and determines if processed data is an indication the nozzle is plugged. In yet another example, the sensor monitors the nozzle assembly orientation and via the automated sprayer diagnostic system 150 processes the information and indicates two adjacent nozzle assemblies are oriented incorrectly.

The sprayer diagnostic controller 152 (a component of the operation system 160 process, a separate processor or the like) identifies performance issues with the sensors 130 and the performance issue catalog 154. The sprayer diagnostic controller in some examples implements remedial action to address the identified performance issues. For example, the sprayer diagnostic controller 152 includes at least one of performance deviation comparator, a performance diagnostic module and a diagnostic indication module. The sprayer diagnostic controller 152 uses observations of the one or more sensors 130 to assess performance of the sprayer including, but not limited to, one or more of nozzle (spray) performance, plumbing, pumps, valves, boom height (e.g., relative to targets) or the like, for instance with the performance deviation comparator. The assessment of performance is compared with performance issues and associated characteristics (including indicative deviations from target values) in the performance issue catalog 154 to identify performance issues with the performance issue diagnostic module. In an example, the performance issue catalog 154 includes remedial actions associated with the respective performance issues, and the sprayer diagnostic system 150 indicates the performance issue and the appropriate remedial actions with the diagnostic indication module. Optionally, the automated sprayer diagnostic system implements the remedial actions to address the associated identified performance issue.

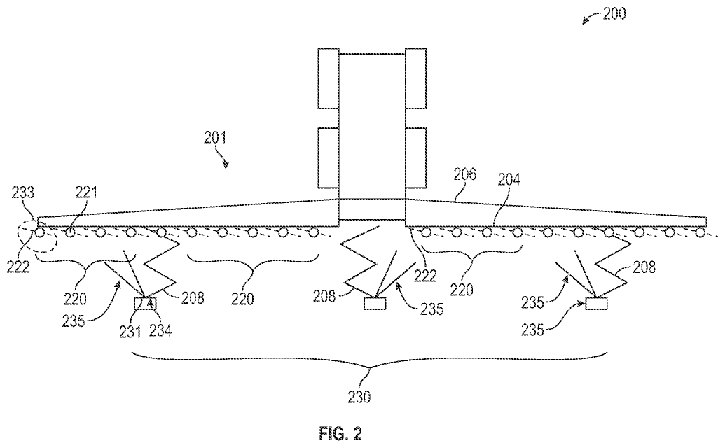

As illustrated in the example of FIG. 2, an agricultural vehicle 200 (also referred to as sprayer 200 herein) has an associated implement 201 for performing an agricultural operation. For example, the agricultural vehicle 200 is a sprayer with one or more associated sprayer booms 206, boom tubes 204 and one or more sprayer nozzle assemblies 220. In an example, there are a plurality of sensors 230 positioned along or proximate to the sprayer boom 206. In an example, the sensor is a camera used to take still images or videos. In another example, the sensor 230 monitors the pattern angle for correct placement of the nozzle assembly. In one example, a sensor boom 208 is coupled with the sprayer boom 206 and directs the sensor 230 towards the one or more sprayer nozzle assemblies 220. In another example, the sensor boom 208 is a moving boom 208 coupled with the sprayer boom 206 that may vary the orientation of the sensor 230 (e.g., with articulating joints, a motor, linkage or the like). For instance, the moving sensor boom 208 traverses one or more sensors of the plurality of sensors 230 to view a plurality of the sprayer nozzle assemblies 220. In another example, the moving sensor boom 208 directs the associated sensor 230 (or sensors) toward one or more of the sprayer nozzle assemblies 220.

In an example, the plurality of sensors 230 coupled to the sensor boom 208, static or moving, view one or more of the sprayer booms 206, boom tubes 204, sprayer nozzle assemblies 220, spray patterns 222 or the like. For example, each sensor 230 positioned on the respective sensor boom 208 is directed 235 toward (potentially movably so) components of the sprayer 200. In some portions herein, the sensors 230 are described as observing one or more nozzle assemblies 220. Observation of one or more nozzle assemblies 220 includes, but is not limited to, observation of the nozzle assembly itself, as well as portions of the implement 201 proximate to the nozzle assemblies 220, such as the boom tube 204, other plumbing components and optionally the zone beneath the nozzle assemblies 220 (e.g., the location of the spray pattern 222 and target for spraying). In an example, the zone beneath the one or more nozzle assemblies 220 includes the dispense area 233 (e.g., zone, region, location, or the like) below or around an orifice of each nozzle 221 of the plurality of nozzles assemblies 220 and in some examples extends between the nozzle assemblies 220 and a target (e.g., crop, pest, soil or the like).

The dispense area 233, optionally includes the zone that the spray pattern 222 occupies when dispensed from the nozzle 221. In the top-down illustration of the spray pattern 222 shown in FIG. 2, the spray patterns 222 have an orientation relative to each other and the sprayer boom 206 to permit pattern overlap without collision between adjacent spray patterns 222 and their associated droplets. The angled and staggered orientation accordingly permits pattern overlap while at the same time maintaining kinematics of the spray droplets (e.g., direction, speed, arc of the pattern or the like).

In another example, a sensor actuator 234 (e.g., stepper motor or the like), orients the sensor 231 toward one or more components of the sprayer 200, such as the one or more nozzle assemblies 220. In one example, the sensor actuator 234 traverses (e.g., pans, covers an arc or the like) the sensor 231 along a plurality of the one or more nozzles assemblies 220 while a diagnostic scheme is implemented (e.g., while the vehicle 200 is static, in operation or the like) to observe actual sprayer performance.

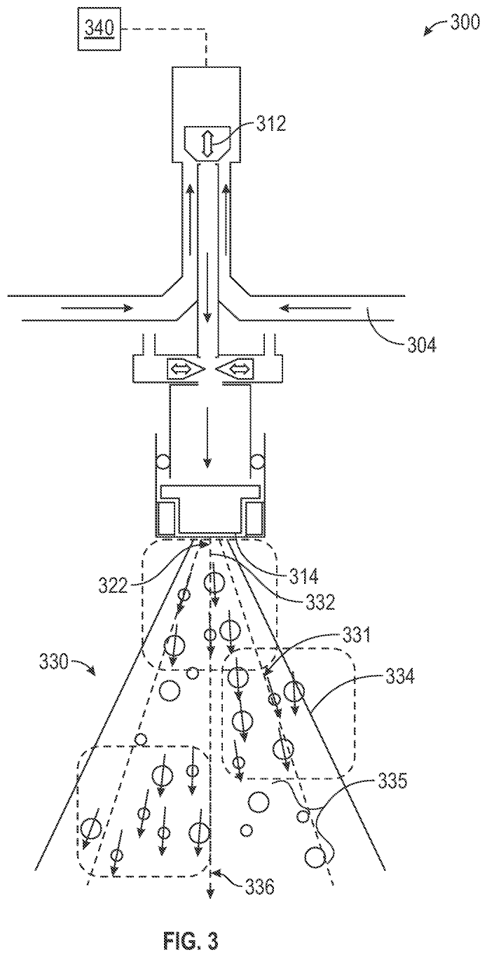

FIG. 3 is a schematic view of an example nozzle assembly 300 with one example of a specified performance profile 330 (e.g., specified spray profile, specified nozzle placement, specified plumbing operation or the like). The nozzle assembly 300 includes, for example, a coupling with a boom tube 304 and a control valve 312 that controls the delivery of agricultural fluid to a nozzle assembly 300. In some examples, the specified performance profile 330 includes performance characteristics associated with the nozzle assembly 300 and potentially portions of the sprayer 200 proximate to the nozzle assembly 300. For example, the specified spray profile 330 may include, but is not limited to, spray characteristics, specified nozzle assembly location (e.g., along a boom), pattern overlap with adjacent spray patterns, plumbing characteristics (e.g., absence of leaks), boom height of the proximate boom or nozzle assembly relative to a target or the like. As used herein, these performance characteristics (spray profile and other performance characteristics) are collectively referred to as a specified performance profile. The agricultural fluid is dispensed from the nozzle assembly 300 through an orifice or a nozzle tip 314 as an example of an actual spray profile. For instance, the agricultural fluid is dispensed as a spray of droplets from the nozzle tip 314 in a (actual) spray profile. As discussed herein the spray profile (actual spray profile) 334 is monitored and compared with the specified spray profile 331 to assess (an example of performance characteristics). An example specified spray profile 331 includes one or more performance characteristics including, but not limited to droplet size (including a range of droplet sizes), spray pattern (arc), droplet kinematics (e.g., direction, velocity) or the like. FIG. 3 shows these characteristics graphically, and in other examples the characteristics are numerically included with the profile 300.

One example of a performance characteristic of the specified performance profile includes a spray origin 332. The spray origin 332 is an example characteristic indicating the location of spray emanation of the dispensed agricultural fluid proximate or a specified origin of the spray profile 330 for the nozzle assembly 300. In some examples, the spray origin 332 corresponds to a specified location of a spray pattern generated by the nozzle assembly 300 relative to a target. In another example, the spray origin 332 corresponds to the location of the nozzle assembly 300 for instance along a sprayer boom. In an example, the nozzle tip 314, the orientation of the nozzle tip 314 and the agricultural fluid dispensed proximate to the nozzle tip 314 are considered components of the spray origin 322.

In another example, the specified performance profile 330 (e.g., a specified spray profile, potentially as part of a larger profile including non-spray components) includes a specified spray pattern 334. The specified spray pattern 334 includes, but is not limited to, one or more of a specified pattern arc or a pattern orientation (e.g., angle of the pattern relative to the plane of the page). In one configuration, the orientation of the specified spray pattern 334 facilitates pattern overlap with minimal collision with a proximate spray pattern dispensed from an adjacent nozzle assembly (as illustrated in the example of FIG. 2). In another configuration, the specified spray pattern 334, for instance as an arc, specifies the location of droplets of the agricultural fluid. For example, the nozzle assembly 300 is specified to spray droplets of agricultural fluid 335 or a stream of agricultural fluid in one or more of a specified direction, orientation, or arc.

In one instance, a specified spray direction 336 corresponds to a vector extending from the spray origin 332 and along a centerline of the spray pattern 334. The vector includes, for example, a virtual line within the spray pattern 334, extending from the spray origin 332 toward a target (e.g., soil, crop, pest or the like) and is equidistant between the boundaries of the observed spray pattern 334. In an example, the sprayer diagnostic system determines a vector of an actual sprayer profile by imputing a virtual line equidistantly between the edges (boundaries including gradient droplet edges) of the observed actual spray profile and then comparing the virtual line with the that of the spray pattern 334 of the specified spray profile. The boundaries of the observed spray pattern 334 (e.g., actual spray pattern) are, for example, the limits the majority of agricultural fluid droplets 335 of the agricultural fluid distributed within the specified spray pattern 334.

In an example, the specified spray pattern defines a droplet size modulation threshold. In some examples, the agricultural fluid droplets 335 distributed from the nozzle assembly 300 have a range of sizes. In an example, the agricultural fluid droplets 335 are dispensed as fine droplets or coarse droplets, or a combination of both. The operational system 160 stores data and processes related to specified droplet sizes. An accumulation of specified droplet sizes is one example of a specified spray profile. In an example, the actual droplet sizes are not in accordance with the data in the operational system 160 of the specified droplet sizes. In such an example, the operational system 160 may alter the droplet sizes.

In one example, the nozzle assembly 300 is in communication with a specified droplet modulation system 340 to alter the agricultural fluid droplet size according to the specified purpose. The droplet modulation system 340, for example, automatically controls the specified droplet modulation characteristic corresponding to a threshold indicative of droplet sizes. In another example, the droplet modulation system 340 changes the size or profile of the agricultural fluid droplets 335 dispensed from the nozzle assembly 300 (e.g., at setting 1 the droplet size is fine, at setting 3 the droplet size is coarse) according to a droplet threshold, logged in at least one of the systems 150, 160, best suited for the specified purpose.

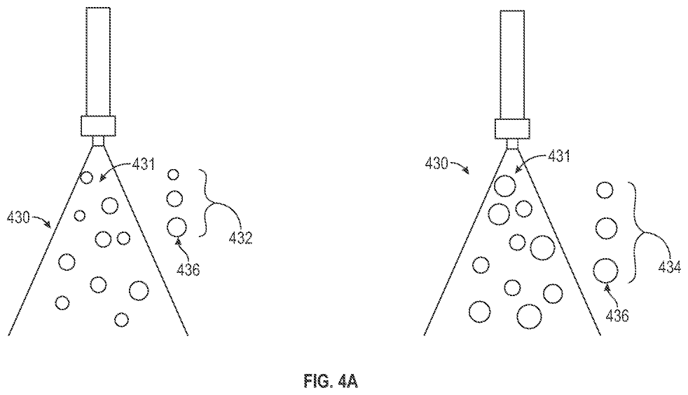

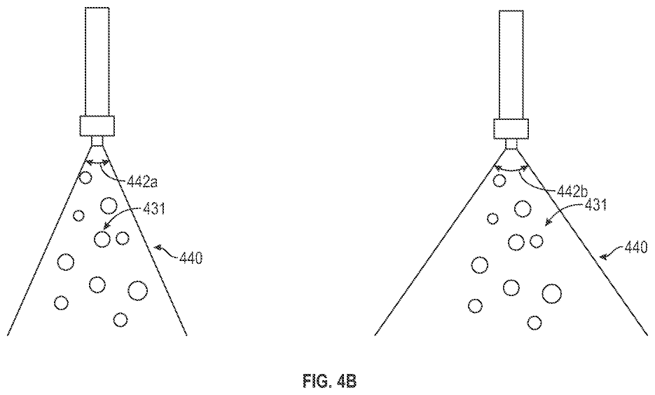

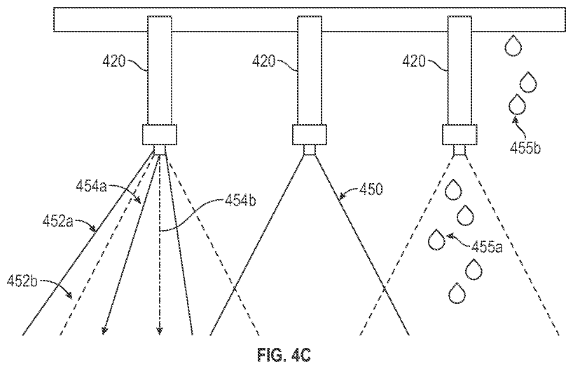

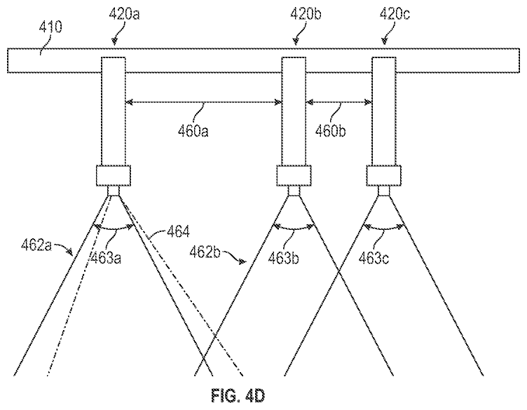

FIG. 4A illustrates actual spray profiles 430 with actual droplets of the sprayer pattern, shown schematically for ease of explanation, adjacent to specified droplet thresholds 432 (sizes, including ranges). As illustrated in the example of FIG. 4A, a droplet threshold, for instance as a characteristic of the specified spray profile (or a specified performance profile) includes a range of droplet sizes 432, 434. In one example, a fine droplet threshold 432 includes about around 60 to 80 percent of the droplets that are fine (as recognized in agricultural spraying), about around 10 to about 20 percent of the droplets are ultrafine (also recognized in agricultural spraying), and about around 10 to about 20 percent of the droplets are coarse (as recognized in agricultural spraying). In another example, the fine droplet threshold 432 includes about around 60 percent to about 80 percent fine droplets while the remaining droplet percentage are left unspecified. Alternatively, another example of a course droplet threshold 434 coarse droplets of about around 60 percent to about 80 percent, fine droplets of about around 10 to 20 percent, and ultracoarse droplets of about around 10 to about 20 percent. In another example, the coarse droplets threshold 434 includes about around 60 to 80 percent course droplets while the remaining droplet percentages are left unspecified. In another example, the droplet threshold can be modulated between the fine droplet threshold 432 and the coarse droplet threshold 434.

In an example, the specified performance spray profile defines a droplet size modulation threshold. For example, during a diagnostic scheme droplet sizes are changed (e.g., modulated) through variations in the spray profile 430 and correspondingly implemented by the droplet modulation system 340 to assess the functionality of the nozzle assembly droplet control capabilities.

In an example, the sensors 130, 230 observe the spray profile 430 (in FIG. 4A or 4B) during modulation. Utilizing the automated sprayer diagnostic system 150 compares monitored droplet size against the droplet size modulation threshold 436 of the specified spray profile to determine deviations between the monitored droplets relative to the droplet size modulation threshold 436. For instance, in an example a droplet size modulation threshold 436 may include droplet sizes that begin ultrafine, proceed through fine, and end as coarse as the modulation range (as shown graphically in FIG. 4A for the threshold 432). The droplet modulation system 340 (valves, nozzles, air inductors or the like) progresses its control to generate actual droplets at the first ultrafine end of the modulation range of ultrafine droplet size, through a portion of the modulation range that is fine and complete the diagnostic scheme at the second end of the modulation range for coarse droplets. The automated sprayer diagnostic system 150 compares actual droplets generated when each portion of the modulation range is implemented. In an example, the sensors 130, 230 include at least one of cameras (still or video), laser reflective sensor, or radar sensors or the like to monitor (e.g., see, observe or the like) the characteristics of spray profiles including droplet sizes, direction, velocity, origin, track of droplets, adhesion of droplets to targets when generated from the nozzle. In one example, the sensor is a camera used to record or take pictures of the nozzle assemblies.

The comparison processed by the processor 151 of the automated sprayer diagnostic system 150 or the system 160 assesses performance deviation of droplet modulation relative to the droplet size modulation threshold 436 (and its variations in droplet size) stored in the performance issue catalog 154. In another example, the droplet size modulation threshold 436, stored in the performance issue catalog 154, includes an intermediate droplet size (e.g., between fine and coarse) for comparison with a sensed actual change in size. In still another example, the modulation threshold 436 includes a continuum of droplet sizes for comparison against a corresponding continuum of droplet sizes observed during implementation of a diagnostic scheme having modulated droplet size control. The sprayer diagnostic controller 152 processes the comparison data from the performance issue catalog 154 against the sensed data from the sensor 130 and provides a diagnostic indication.

Additionally actual spray profiles 440 are shown in the side-by-side profiles provided in FIG. 4B that illustrate example the actual spray profiles overlayed with the spray arcs 442a, 442b as specified thresholds. In an example, actual spray, and the agricultural spray threshold is used to guide performance of the nozzle assembly. In this case the spray arc 442a causes the elements of the nozzle assembly (e.g., a modulating nozzle tip) to constrain spray output to an arc corresponding to 442a through feedback to the automated sprayer diagnostic system 150. For example, monitoring of actual spray profile and guiding control toward the threshold based on detected deviation from the threshold and minimizing of those deviations.

In the example illustrated in FIG. 4B, as the droplets 431 are dispensed from the at least one nozzle assembly. The droplets 431 fan or are sprayed as a mist having a pattern or arc. In one example, the droplets 431 are sprayed in an arc based on a specified threshold value, spray arc 442a in the left view and spray arc 442b in the right view. As an example, arc 442b is the threshold for the actual spray profile on the right. The one or more sensors 130, 230 monitor (e.g., observes or senses) and communicates with the automated sprayer diagnostic system 150 to determine deviations relative to 442b, and makes adjustments (likely at the nozzle) to decrease deviations and achieve the threshold value (i.e., that the actual spray profile matches the art 442b threshold).

The actual spray profile 440 and the spray arc 442a have narrower arcs than the arc 442b and its associated spray profile 440 in the right view. For example, an agricultural action (e.g., speed of sprayer, testing sprayer system or the like), a specific target (e.g., soil, crops, pests or the like) or environmental conditions are inputs or are monitored by the sensors and transmitted to the operation system 160. The operation system 160 then controls the specified spray pattern arc 442a, 442b according to the threshold. In an example, the operation system 160 changes the threshold (the specified spray pattern arcs) according to the one or more inputs from the observed or sensed environmental conditions. For example, on a windy day the operation system 160 via the automated sprayer diagnostic system 150 applies logic or processes so the sprayer dispenses agricultural fluid with a narrower, or smaller, spray pattern arc 442a. In another example additional agricultural fluid is specified for application to a target (e.g., soil, crop, pests or the like) or a greater boom height is specified the automated sprayer diagnostic system 150 (or operation system 160) changes the spray pattern arc to a narrower setting, such as that shown with the arc 442a, to ensure plant foliage is covered and decrease the waste of fluid. In another example, the arc 442b is increased to ensure coverage of the plant foliage and the boom height is lowered to be closer to the plant.

The example spray pattern arcs 442a, 442b, in another example, are specified by the location of the at least one nozzle assembly 420 along the boom, and accordingly may vary along the boom. The spray pattern arcs 442a, 442b illustrated in FIG. 4B, are one characteristic to determine the overall spray profile 440 (e.g., the area or zone in which the majority of droplets are distributed from the at least one nozzle).

In an example illustrated in FIG. 4C, the actual spray patterns 450 are angled relative to each other, for instance into and out of the page, diagonal relative to the centerline 454b or the like. For example, the actual spray patterns 450 are angled relative to each other to permit pattern overlap without collision between the spray patterns 450 that would affect the kinematics of the spray droplets.

In an example, the actual spray pattern 452a deviates or is outside of the threshold 452b set by the automated sprayer diagnostic system 150 or a sprayer controller, such as the operation system 160. For example, the actual spray pattern 452a is offset relative to the preferred orientation direction 454b. The actual spray pattern centerline 454a is an example of an indication of misalignment of the spray pattern in some examples, results in gaps between adjacent spray patterns 450. Misalignment 454a, in other examples, results in enhanced overlapping and a corresponding excess of agricultural fluid distributed in certain zones or regions.

In another example, excess droplets 455b are distributed outside of at least one nozzle assembly 420. For instance, excess droplets 455b are dispensed from a zone or region where there is no nozzle assembly (e.g. a hole in plumbing). Excess droplets or relatively large droplets 455a are, for example, dispensed from at least one nozzle assembly 420, such as a failing or failed nozzle assembly 420. The droplets 455a result in an excess of agricultural fluid distributed or agricultural fluid applied to targeted surfaces in a less effective and efficient manner.

In the example illustrated in FIG. 4D, when the nozzle assemblies 420a, 420b, 420c, are not properly spaced along a sprayer boom 410 (placed, set, distributed) the agricultural fluid is correspondingly distributed poorly with some areas extensively overlapped and others without overlap. For example, the spacing 460a between a first nozzle assembly 420a and a second nozzle assembly 420b is wider, or further apart, than the spacing 460b between the second nozzle assembly 420b and the third nozzle assembly 420c. In such an example, a wider gap (beyond specification) between spray patterns may negatively decrease the application of agricultural fluid to a target area. In another example, the nozzle assemblies 420a, 420b, 420c are distributed at irregular intervals along the sprayer boom 410. For example, in a situation with targets are irregularly, but linearly, spaced, in a field the nozzle assemblies have a corresponding spacing along the sprayer boom. In each example, the nozzle assemblies 420a, 420b, 420c have one or more of a specified location, spacing or the like (e.g., thresholds) along the sprayer boom 410. In one example, the automated sprayer diagnostic system 150 or operating system 160 includes one or more the specified locations, spacings or the like for the nozzle assemblies and the one or more sensors 230 (see FIG. 2) monitors (e.g., observes or senses) the nozzle assemblies (e.g., spray origin, nozzle body, nozzle tip or the like) for spacing or position deviations outside of the spacing or position thresholds (e.g., specified spacing, locations or the like) programed into the automated sprayer diagnostic system 150.

In the example illustrated in FIG. 4D, when the nozzle assemblies 420a, 420b, 420c, are not properly aligned (placed, set, distributed) along a boom 410. The one or more sensors 130, 230 monitor (e.g., observes or senses) the nozzle assemblies 420a, 420b, 420c and transmits the data related to the nozzle assemblies 420a, 420b, 420c positions. Via at least one feedback loop associate with the systems 150, 160, the system 150, 160 determines the agricultural fluid dispensed from the nozzle assemblies is not properly distributed. For example, the specified spray pattern 462a and the actual spray pattern 464 do not align so the actual spray pattern 464 crosses into an adjacent spray pattern 462b.

In another example illustrated in FIG. 4D, there is a fault with one component of the nozzle assembly presents a performance issue and there are no other performance issues with other components of the nozzle assembly or spray pattern. For example, the one or more sensors 130, 230 monitor (e.g., observes or senses) spacing between nozzle assemblies 460a, 460b is incorrect but also monitors (e.g., observes or senses) the spray pattern arcs 463a, 463b, or 463c are equal and align with the specified spray pattern arc. In such an example, the one or more sensors 130, 230 monitor the placement of the nozzle assemblies 420a, 420b and 420c simultaneously, or after a specified time, monitors the spray pattern arc 463a, 463b, and 463c. In an example, the sensor 130, 230 also monitors (e.g., observes or senses) the spray pattern 462a, 462b and simultaneously, or after a specified time, monitors either or both the spray pattern arc 463a, 463b, 463c and the nozzle assembly 420a, 420b, 420c placement.

As discussed related to FIGS. 3 and 4A-4D, there are predicted and unpredicted performance issues and performance characteristics with specified performance thresholds (e.g., spray pattern deviations or droplet size deviations). In an example, performance deviations between the actual performance (e.g., observed sprayer performance through the sensor 130, 230) and the specified sprayer profile are indicative of one or more performance issues. For example, the sensor 130, 230 works in conjunction with the automated sprayer diagnostic system 150 to recognize and diagnose issues with the sprayer or sprayer components.

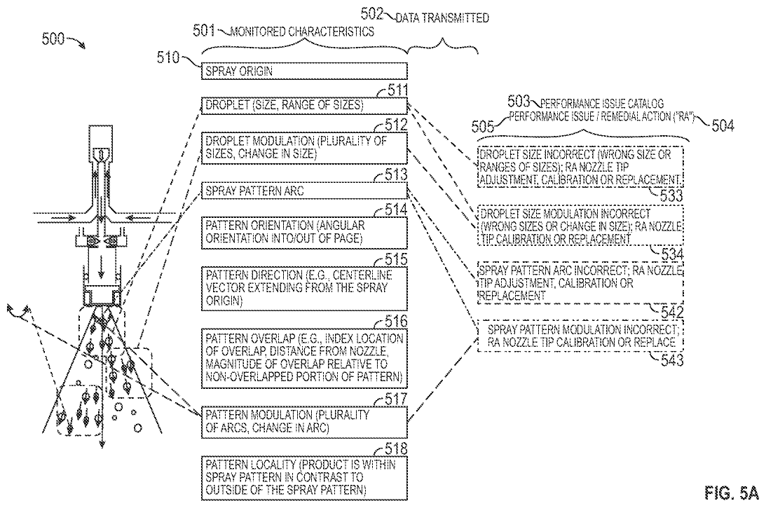

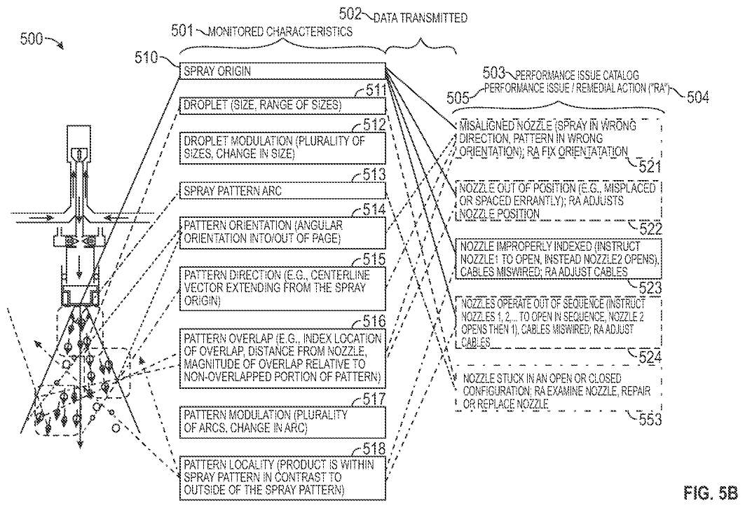

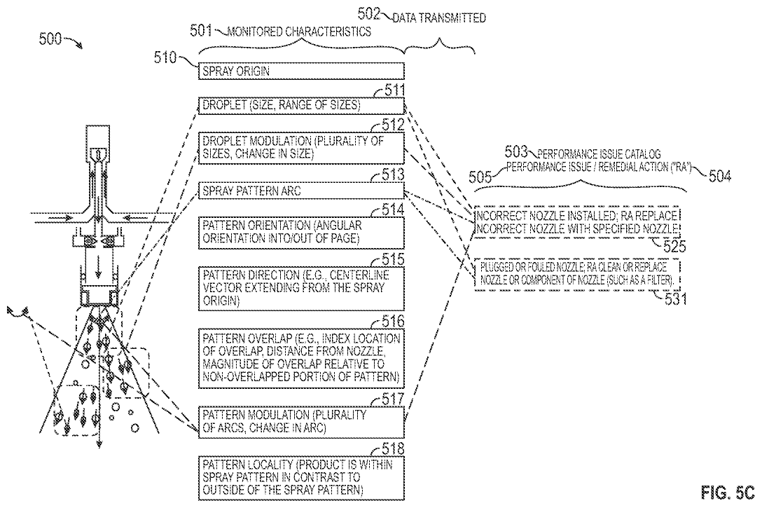

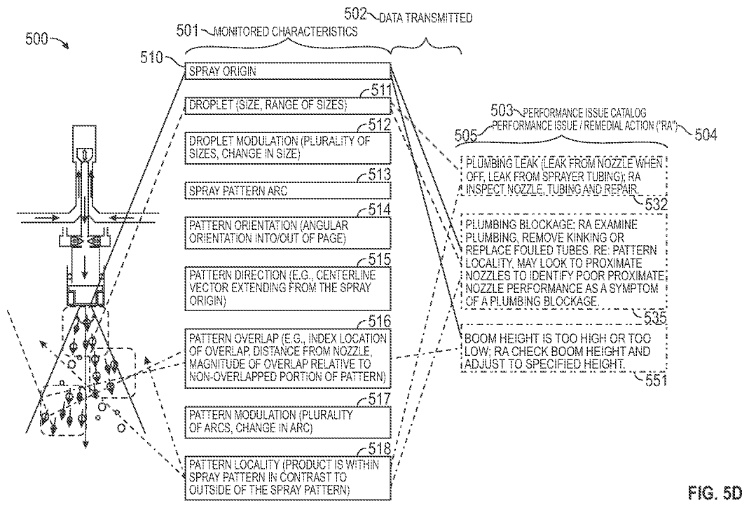

Illustrated in FIGS. 5A through 5D are examples of a performance issue catalog including a non-exclusive list of performance includes. FIGS. 5A through 5D further illustrate example schematics of a nozzle assembly and portions of a sprayer system proximate to the nozzle assembly including plumbing, spray pattern generated from the nozzle assembly or the like. The dashed lines illustrated in FIGS. 5A through 5D extend from the various locations on and around the nozzle assembly and are connected or associated with corresponding characteristics that are, in various examples, monitored by the system 150 at the respective location on or proximate to the nozzle assembly.

These characteristics, such as their monitored values, are provided to the system 150 and compared with specified characteristics (thresholds) associated with respective performance issues (e.g., provided by the system 150, operating system 160 or the like). In one example, a performance issue is present with the monitored sprayer system 100 where the comparisons done by the system 150 indicate that one or more (or each) of the monitored characteristics associated with a performance issue satisfy the threshold values (specified characteristics) associated with those performance issues. In this example, the threshold values (also referred to as specified characteristics) correspond to values that are indicative of fault, error, malfunctioning or failed components (e.g., ‘bad’ behavior). In other examples, the threshold values or specified characteristics correspond to specified performance values that are specified (i.e., desired) for ‘good’ behavior, and deviations from these values, for instance a specified degree or value of deviation are indicative of fault, error or malfunctioning or failed components.

In an example of the diagnostic system, as discussed in relation to FIG. 1, for instance including the sensors 130, 230, monitors one or more nozzle assemblies 120, 220 and their associated performance during implementation of a diagnostic scheme. The actual performance profiles and the specified performance profiles (thresholds, target values or the like) of the one or more monitored nozzle assemblies may vary (e.g., based on boom location, the associated target or zone of coverage for the nozzle assembly or the like) thereby providing multiplicative variations in performance based on the number of observed nozzle assemblies and associated actual and specified performance profiles. The operating system 160, diagnostic system 150 or the like operate separately or together to monitor deviations of the actual performance profiles from specified performance profiles and guide performance of the nozzle assemblies toward the specified performance profiles (e.g., with a comparator, gains, and the like used as components of a feedback controller or controllers of the systems 150, 160).

In an example, the systems 150, 160 feedback controller or controllers provide data for analysis to the automated diagnostic system 150. The automated diagnostic system 150 assesses deviations of the actual performance profiles relative to the specified performance profiles based on comparison therebetween, for instance with the performance deviation comparator shown in FIG. 1. In various examples, monitored characteristics 501 (in FIGS. 5A through 5D) of an actual performance profile (e.g., actual spray pattern, observations of the sprayer in process or the like) are compared with specified characteristics of the specified performance profiles with the performance deviation comparator (see FIG. 1) to determine performance deviations. As discussed herein, the automated diagnostic system 150 accesses the library of performance issues in the performance issue catalog 154 to facilitate the determination of performance issues through analysis of deviations. By comparing the data associated with the actual performance profile (e.g., deviations from the specified performance profile, achieving thresholds indicative of performance issues or the like) with the library of performance issues, the automated diagnostic system 150 identifies performance issues, selects the appropriate remedial action (or actions), and in some examples implements remedial actions.

An example performance issue catalog 503 is shown in FIGS. 5A through 5D along with component performance issues 504 (including issues 521-551) and associated remedial actions 505. The performance issues 504 include, but are not limited to, example sprayer issues such as orientation of one or more nozzle assemblies, spray patterns or droplet profiles.

FIGS. 5A through 5D further includes monitored (e.g., observed or sensed) characteristics 501, for instance provided by the one or more sensors 130, 230 for interpretation by the automated diagnostic system 150. The characteristics 501, deviations of characteristics from specified thresholds or the like are in one example compared with the performance issues 503 of the performance issue catalog 154, for instance the thresholds, specified characteristics, specified deviations or the like that are associated with the various performance issues 503.

The automated diagnostic system 150, its components such as the sprayer diagnostic controller 152 (e.g., comparator, indicator, diagnostic module, indication module) and the performance issue catalog 154 are, in one example, components of a processor, for instance maintained on one or more of the sprayer 100 or a remote location (e.g., local server, cloud server or the like). The processor, in an example, includes memory, software or the like for receiving, relaying, and analyzing the monitored characteristics 501. Further, the processor (e.g., memory, software or the like) cooperatively conducts analysis between the sprayer diagnostic controller 152, of the automated sprayer diagnostic system 150, and the performance issue catalog 154 (503 in FIGS. 5A through 5D) to identify performance issues 505 and the associated remedial action 504.

In an example, the sprayer diagnostic controller 152 via a performance deviation comparator receives the monitored characteristics (501 in FIGS. 5A and 5B) of the actual spray profile. The sprayer diagnostic controller 152 via, for example the performance deviation comparator (“PDC”) accesses a specified performance profile (having its own specified characteristics). In an example, the sprayer diagnostic controller 152 may be located with the system 160 or 150. For example, the sprayer diagnostic controller 152 also accesses thresholds provided with the performance issue catalog 154, 503 (herein “PIC”). The sprayer diagnostic controller 152 or the PDC then compares actual monitored characteristics (501 in FIG. 5A though 5D) from the sensors with the specified characteristics (from 150 or 160), thresholds in the PIC 154, 503, or the like. The sprayer diagnostic controller 152 or the PDC determines performance deviations. In one example, performance deviations include deviations of the actual profile from the specified profile (e.g., monitored droplet size is below or above specification for the present agricultural fluid application). In another example, performance deviations include achieving or satisfying a threshold (e.g., instead of a numerical deviation) in the PIC 154, 503; for instance, if spray origin is greater than 5 cm from a specified location. Both of these, deviations from a specification and achieving or satisfying thresholds (of the PIC) are collectively performance deviations.

These performance deviations are analyzed with the sprayer diagnostic controller 152, such as the performance issue diagnostic module (PIDC), in cooperation with the PIC 154, 503. The PIDC analyses the PIC based on the collected performance deviations and identifies performance issues (e.g., one or more of 521-551). For instance, the PIDC determines correspondence of the collected performance deviations with PIC performance issues, more specifically, the stored deviations, threshold achievements, or the like associated with respective performance issues and indicative of that performance issue. The correspondence between the performance deviations and a performance issue (e.g., its stored deviations, threshold achievements, etc. indicative of the performance issue) is indicative of a confidence or likelihood of that performance issue.

In an example of the automated sprayer diagnostic system 150 or the operational system 160, there are different methods to determine the correspondence between the performance deviations and the performance issue. For example, associated deviations and threshold achievements for each performance issue (505 in FIGS. 5A though 5D) are optionally weighted according to priority (e.g., likelihood that one deviation or achievement is indicative of that performance issue). Performance deviations are assigned a unitless numerical value (optionally adjusted based on a gain for priority) and summed. The performance issue is identified when the performance deviations that are determined with the PDC sum to a specified value (e.g., a unitless numerical value) that exceeds a performance issue threshold number, for instance a unitless value of 7 on a scale of 1 to 10.

In another example, associated deviations and threshold achievements for each performance issue are counted. For example, the performance issue is identified when the counted number of deviations and threshold achievements meet or exceed a threshold count value for characteristics associated with the performance issue, such as 3 performance deviations out of a possible 5 performance deviations for a specific performance issue are detected.

In an example, the performance issue diagnostic module transmits the identified performance issue to the diagnostic indication module that notifies the presence of the performance issue and indicates to the user the remedial action to be taken.

Various performance issues and example identifications of those issues are provided herein. The example performance issues and their identifications are representative of the identification of multiple and varied types of performance issues, and accordingly the automated sprayer diagnostic system 150 is capable of identifying these performance issues as well as their equivalents.

A misaligned nozzle 521 (e.g., the spray is in the wrong direction or the pattern is in the wrong orientation) (see FIG. 5B) is one example of a performance issue. In an example, to determine the nozzle is misaligned, the performance deviation comparator of the sprayer diagnostic controller 152 compares measured values of the monitored characteristics 501 with a specified performance profile (e.g., specified characteristics associated with a specified agricultural operation for the vehicle). For example, the sensors 130, 230 monitor (e.g., observes or senses) a spray origin 510, the spray pattern orientation 514, a spray pattern direction 515 or spray pattern overlap 516. The sprayer diagnostic controller 152 compares the monitored (actual) spray origin 510 with the specified spray origin 510; the monitored (actual) the spray pattern orientation 514 with the specified spray pattern orientation; the monitored (actual) spray pattern direction 515 with the specified spray pattern direction; or the monitored (actual) spray pattern overlap 516 with the specified spray pattern overlap. The one or more sensors monitor the spray origin 510 and one or more of the agricultural operation system 160 or the diagnostic system 150 recognizes (e.g., determines the deviation) the spray origin is not dispensing agricultural fluid according to specific values representative of a specified location of the spray origin (e.g., location on a boom, spacing from a proximate nozzle or fiducial or the like) logged in the catalog (see FIG. 4D). In another example of nozzle misalignment 521, the sensor monitors the pattern orientation 514 of the actual spray pattern and the agricultural operation system 160 or the automated sprayer diagnostic system 150 determines a deviation of the actual spray pattern relative to the specified pattern orientation logged in the catalog (see FIG. 4D). In one example, the sensor monitors the pattern direction 515 (e.g., a vector corresponding to a centerline) and the agricultural operation system 160 determines a deviation of the vector relative to the specified direction (vector) logged in the catalog (see FIG. 4C). In another example of nozzle misalignment 521, the sensor monitors the spray pattern overlap 516 between two adjacent nozzle assemblies and the agricultural operation system 160 or the automated sprayer diagnostic system 150 determines a deviation of overlap relative to specified values for overlap in the catalog (see FIG. 4C). Each of these comparisons or a combination of comparisons, for example, determines performance deviations of the nozzle.

In an example, the performance issue diagnostic module of the sprayer diagnostic controller 152 identifies the misaligned nozzle through cooperation with the performance issue catalog 154, 503. If the determined performance deviations correspond with the monitored characteristics outside of thresholds or satisfying thresholds (depending on the characteristic and threshold) set for the performance issue (e.g., a misaligned nozzle performance issue in this example) the performance issue is considered present. In the present example, one or more of the determined performance deviations are indicative of the misaligned nozzle. In another example, a plurality of the performance deviations for the misaligned nozzle performance issue provide increased confidence the misaligned nozzle performance issue is present.

An indication of the misaligned nozzle through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. For example, the remedial action alerts the operator to check the nozzle orientation. In another example, the systems 150, 160 may automatically reorient the nozzle.

A nozzle out of position 522 (e.g., misplaced or spaced errantly) (see FIG. 5B) is one example of a performance issue. In an example, to determine the nozzle is out of position, the performance deviation comparator of the sprayer diagnostic controller 152 compares the monitored characteristics 501 with specified performance profile (e.g., specified characteristics associated with a specified agricultural operation for the vehicle). For example, one or more the sensors 130, 230 monitor (e.g., observes or senses) a spray origin 510 or pattern overlap 516. The sprayer diagnostic controller 152 compares the monitored (actual) spray origin 510 with the specified spray origin 510; the monitored (actual) spray pattern overlap with the specified spray pattern overlap. In an example, one or more sensors monitor the spray origin 510 and the agricultural operation system 160 or the automated sprayer diagnostic system 150 determines the spray origin is not in the correct location according to the threshold values (e.g., location on a boom, angle of orientation, spacing from a proximate nozzle or fiducial or the like) logged in the catalog (see FIG. 4D). In an example, the one or more sensors monitor the spray pattern overlap 516 and the agricultural operation system 160 determines the magnitude of the spray pattern overlap 516 is not oriented correctly according to the threshold values logged in the catalog (see FIG. 4C). Each of these comparisons or a combination of comparisons, for example, determines performance deviations of the nozzle position.

In an example, the performance issue diagnostic module of the sprayer diagnostic controller 152 identifies the nozzle out of position through cooperation with the performance issue catalog 154, 503. If the determined performance deviations corresponds with the monitored characteristics outside of the thresholds or satisfying thresholds (depending on the characteristic and threshold) set for the performance issue (e.g. out of position nozzle performance issue in this example) The performance issue is considered present. In the present example, one or more of the determined performance deviations are indicative of the nozzle out of position. In another example, a plurality of the performance deviations for the nozzle out of position performance issue provide increased confidence the nozzle out of position performance issue is present.

An indication of the nozzle out of position through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. For example, the remedial action alerts the operator to check the nozzle position. In another example, the systems 150, 160 may automatically adjust the nozzle.

A plugged or fouled nozzle 531 (see FIG. 5C) is an example of an identified performance issue. In an example, to determine the nozzle is plugged or fouled, the performance deviation comparator of the sprayer diagnostic controller 152 compares certain monitored characteristics 501 with specified performance profile. For example, the one or more sensors 130, 230 monitor (e.g., observes or senses) specific characteristics such the droplets 511 dispensed or spray pattern arc 513. In another example, the sprayer diagnostic controller 152 compares the monitored (actual) droplet size with the specified droplet size or the monitored (actual) spray pattern arc with the specified spray pattern arc. In an example, the one or more sensors 130, 230 monitors the droplet size 511 and the agricultural operation system 160 determines the droplets 511 are not the correct size or range of sizes according to the threshold values logged in the catalog (see FIG. 4A). In an example, the one or more sensors monitor the spray pattern arc 513 and the agricultural operation system 160 determines the angle of the spray pattern arc 513 is too wide or too narrow according to the threshold values logged in the catalog (see FIG. 4C). Each of these comparisons or a combination of comparisons, for example, determines performance deviations of a plugged or fouled nozzle.

In an example, the performance issue diagnostic module of the sprayer diagnostic controller 152 identifies the nozzle is plugged or fouled through cooperation with the performance issue catalog 154, 503. If the determined performance deviations correspond with the monitored characteristics outside of thresholds or satisfying thresholds (depending on the characteristic and threshold) set for the performance issue (e.g., a plugged or fouled nozzle performance issue in this example) the performance issue is considered present. In the present example, one or more of the determined performance deviations are indicative of a plugged or fouled nozzle. In another example, a plurality of the performance deviations for the plugged or fouled nozzle performance issue provide increased confidence the plugged or fouled nozzle performance issue is present. An indication of a plugged or fouled nozzle through cooperation with a diagnostic indication module via the sprayer diagnostic controller 152 provides an example of a remedial action. In an example, the remedial action is likely to alert the operator to clean or replace the nozzle or component of the nozzle (such as a filter). In another example, the systems 150, 160 may automatically clean the nozzle

A plumbing leak 532 (e.g., a leak from the nozzle when the nozzle is off or a leak from the sprayer tubing) (see FIG. 5D) is an example of an identified performance issue. In an example, to determine the plumbing has a leak, the performance deviation comparator of the sprayer diagnostic controller 152 compares certain monitored characteristics 501 with specified performance profile. For example, the one or more sensors 130, 230 monitor (e.g., observes or senses) specific characteristics such the droplets 511 dispensed or spray pattern locality 518.

In an example, the sprayer diagnostic controller 152 compares the monitored (actual) droplet size with the specified droplet size; the monitored (actual) spray pattern locality with the specified spray pattern locality. In an example, the sensor monitors the droplet size 511 and the agricultural operation system 160 determines the droplets 511 are not the correct size or range of sizes according to the threshold values logged in the catalog (see FIG. 4A). In an example, the sensor monitors the spray pattern arc 513 and the agricultural operation system 160 the determines the location of the agricultural target in relation to the spray pattern is not in a location according to the threshold values logged in the catalog (see FIG. 4D). Each of these comparisons or a combination of comparisons, for example, determines performance deviations of a plumbing leak.

In an example, the performance issue diagnostic module of the sprayer diagnostic controller 152 identifies the plumbing leak through cooperation with the performance issue catalog 154, 503. If the determined performance deviations corresponds with the monitored characteristics outside of thresholds or satisfying thresholds (depending on the characteristic and threshold) set for the performance issue (e.g., a plumbing leak performance issue in this example) the performance issue is considered present.

An indication of the plumbing leak through cooperation with a diagnostic indication module via the sprayer diagnostic controller 152 provides an alert to the user or an indication of the performance issue is transmitted to the systems 150, 160 to perform a remedial action. In an example, the indication includes an associated remedial action, or the remedial action is a separate, but related action. For example, the indication of the remedial action to the system 150, 160 triggers the implementation of the specified remedial action. For example, the remedial action alerts the operator to check the inspect the nozzle and tubing and if necessary perform repairs. In another example, the systems 150, 160 may automatically check the nozzle or the tubing.

An improperly indexed nozzle 523 (e.g., instruction for nozzle 1 to open, instead nozzle 2 opens) (see FIG. 5B) is an identified performance issue. In an example, to determine the nozzle is improperly indexed, the performance deviation comparator of the sprayer diagnostic controller 152 compares the monitored characteristics 501 with specified performance profile (e.g., specified characteristics associated with the monitored characteristic 501). For example, the one or more sensors 130, 230 monitor (e.g., observes or senses) the fluid dispensed at the spray origin 510. In another example the one or more sensors 130, 230 monitor the pattern locality 518 (e.g., the product is within the spray pattern in contract to the product is outside of the spray pattern). The sprayer diagnostic controller 152 compares the monitored (actual) spray origin 510 with the specified spray origin 510 or compares the monitored (actual) pattern locality 518 with the specified pattern locality 518. This comparison, for example, determines performance deviations.

In an example, the performance issue diagnostic module of the sprayer diagnostic controller 152 identifies the performance issue (e.g., improperly indexed nozzle 523) through cooperation with the performance issue catalog 154, 503. If the determined performance deviations correspond with the monitored characteristics outside of thresholds or satisfying thresholds (depending on the characteristic and threshold) set for the performance issue (e.g., a improperly indexed nozzle performance issue in this example) the performance issue is considered present. In the present example, one or more of the determined performance deviations are indicative of an improperly indexed nozzle. In another example, a plurality of the performance deviations for the improperly indexed nozzle performance issue provide increased confidence the improperly indexed nozzle performance issue is present.

An indication of the improperly indexed nozzle through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. In an example, the remedial action is likely to alert the operator to check the nozzle indexing and cables. In another example, the systems 150, 160 may automatically switch indexing if cables are determined to be flipped (e.g., nozzle 12 has nozzle 13's cables, and nozzle 13 has nozzle 12's cables).

A nozzle operating out of sequence 524 (e.g., instructions for nozzle 1, 2, 3, . . . to open in sequence, nozzle 2 opens the nozzle 1) (see FIG. 5B) is an identified performance issue. In an example, to determine the nozzles are operating out of sequence, the performance deviation comparator of the sprayer diagnostic controller 152 compares the monitored characteristics 501 with specified performance profile (e.g., specified characteristics associated with the monitored characteristic 501). For example, the one or more sensors 130, 230 monitor (e.g., observes or senses) the fluid dispensed at the spray origin 510. In another example the one or more sensors 130, 230 monitor the pattern locality 518 (e.g., the product is within the spray pattern in contract to the product is outside of the spray pattern). The sprayer diagnostic controller 152 compares the monitored (actual) spray origin 510 with the specified spray origin 510 or compares the monitored (actual) pattern locality 518 with the specified pattern locality 518. This comparison, for example, determines performance deviations.

In an example, the performance issue diagnostic module of the sprayer diagnostic controller 152 identifies the performance issue (e.g., nozzles operating out of sequence 524) through cooperation with the performance issue catalog 154, 503. If the determined performance deviations correspond with the monitored characteristics outside of thresholds or satisfying thresholds (depending on the characteristic and threshold) set for the performance issue (e.g., nozzle operating out of sequence performance issue in this example) the performance issue is considered present. In the present example, one or more of the determined performance deviations are indicative of a nozzle operating out of sequence. In another example, a plurality of the performance deviations for the nozzle operating out of sequence performance issue provide increased confidence the nozzle operating out of sequence performance issue is present.

An indication of the nozzle operating out of sequence through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. For example, the remedial action alerts the operator to check the nozzle wiring or cables. In another example, the systems 150, 160 may automatically switch the signals transmitted by the wiring or cables.

An incorrect nozzle is installed 525 (see FIG. 5C) is an identified performance issue. In an example, to determine an incorrect nozzle is installed, the performance deviation comparator of the sprayer diagnostic controller 152 compares the monitored characteristics 501 with specified performance profile (e.g., specified characteristics associated with the monitored characteristic 501). For example, the one or more sensors 130, 230 monitor (e.g., observes or senses) the fluid dispensed at the spray origin 510. In another example the one or more sensors 130, 230 monitor the droplets dispensed 511 (e.g., droplet size or range of sizes). In an example, the sensor monitors the droplet modulation 512 (e.g., plurality of droplet sizes, changes in droplet sizes). In another example, the one or more sensors 130, 230 monitor the spray pattern arc 513. The sprayer diagnostic controller 152 compares the monitored (actual) spray origin 510 with the specified spray origin 510; the monitored (actual) droplets dispensed 511 with the specified droplets dispensed; the monitored (actual) droplets modulation 512 with the specified modulation; the monitored (actual) spray pattern arc with the specified spray pattern arc; or compares the monitored (actual) pattern locality 518 with the specified pattern locality 518. This comparison, for example, determines performance deviations.

In an example, the performance issue diagnostic module of the sprayer diagnostic controller 152 identifies the performance issue (e.g., incorrect nozzle installed 525) through cooperation with the performance issue catalog 154, 503. If the determined performance deviations correspond with the monitored characteristics outside of thresholds or satisfying thresholds (depending on the characteristic and threshold) set for the performance issue (e.g., incorrect nozzle installed performance issue in this example) the performance issue is considered present. In the present example, one or more of the determined performance deviations are indicative of an incorrect nozzle installed. In another example, a plurality of the performance deviations for the incorrect nozzle installed performance issue provide increased confidence the incorrect nozzle installed performance issue is present.

An indication of the incorrect nozzle installed through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. For example, the remedial action alerts the operator to check the nozzle installed and replace the nozzle.

An incorrect droplet size 533 (e.g., wrong droplet size or ranges of sizes) (see FIG. 5A) is an example of an identified performance issue. In an example, to determine incorrect droplet sizes, the performance deviation comparator of the sprayer diagnostic controller 152 compares the monitored droplet size 511 or range of sizes with specified performance profile (e.g., specified characteristics associated with the actual droplet sizes). This comparison, for example, determines performance deviations.

In an example, the performance issue diagnostic module of the sprayer diagnostic controller 152 identifies the incorrect droplet size through cooperation with the performance issue catalog 154, 503. If the determined performance deviations correspond with the monitored characteristics outside of thresholds or satisfying thresholds (depending on the characteristic and threshold) set for the performance issue (e.g., incorrect droplet size performance issue in this example) the performance issue is considered present. In the present example, one or more of the determined performance deviations are indicative of an incorrect droplet size. In another example, a plurality of the performance deviations for an incorrect droplet size performance issue provide increased confidence the incorrect droplet size performance issue is present.

An indication of the incorrect droplet size through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. In an example, the remedial action is likely to alert the operator to check or replace the nozzle or the recalibrate the nozzle or nozzle tip.

An incorrect droplet size modulation 534 (e.g., wrong size or ranges of sizes) (see FIG. 5A) is an example of an identified performance issue. In an example, to determine incorrect droplet size modulation, the performance deviation comparator of the sprayer diagnostic controller 152 compares the monitored the droplet size 511 or the droplet modulation 512 with specified performance profile (e.g., specified characteristics associated with the actual droplet sizes or the droplet size modulation). This comparison, for example, determines performance deviations.

In an example, the performance issue diagnostic module of the sprayer diagnostic controller 152 identifies the incorrect droplet size modulation through cooperation with the performance issue catalog 154, 503. If the determined performance deviations correspond with the monitored characteristics outside of thresholds or satisfying thresholds (depending on the characteristic and threshold) set for the performance issue (e.g., incorrect droplet size modulation nozzle performance issue in this example) the performance issue is considered present. In the present example, one or more of the determined performance deviations are indicative of an incorrect droplet size modulation. In another example, a plurality of the performance deviations for the incorrect droplet size modulation performance issue provide increased confidence the incorrect droplet size modulation nozzle performance issue is present.

An indication of the incorrect droplet size modulation through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. In an example, the remedial action is likely to alert the operator to check or replace the nozzle or the recalibrate the nozzle or nozzle tip.

In one example, a plumbing blockage 535 (see FIG. 5D) is an identified performance issue. In an example, to determine there is a plumbing blockage, the performance deviation comparator of the sprayer diagnostic controller 152 compares the monitored the spray origin 510, the droplet size 511 or the pattern locality 518 with specified performance profile of each monitored characteristic. This comparison, for example, determines performance deviations.

In an example, the performance issue diagnostic module of the sprayer diagnostic controller 152 identifies the plumbing blockage through cooperation with the performance issue catalog 154, 503. If the determined performance deviations correspond with the monitored characteristics outside of thresholds or satisfying thresholds (depending on the characteristic and threshold) set for the performance issue (e.g., plumbing blockage performance issue in this example) the performance issue is considered present. In the present example, one or more of the determined performance deviations are indicative of plumbing blockage. In another example, a plurality of the performance deviations for the plumbing blockage performance issue provide increased confidence the plumbing blockage performance issue is present.

An indication of the plumbing blockage through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. In an example, the remedial action is likely to alert the operator to check or replace kinked or fouled tubes. In another example, if pattern locality is indicative of kinked or fouled tubes, the systems 150, 160 may monitor or identify proximate nozzles performing poorly and thereby provide an indication to check or replace kinked or fouled tubes.

An incorrect spray pattern arc 542 (see FIG. 5A) is an example of an identified performance issue. In an example, to determine there is an incorrect spray pattern arc, the performance deviation comparator of the sprayer diagnostic controller 152 compares the monitored angle of the dispensed agricultural fluid spray pattern arc 513 with specified performance profile of the monitored characteristic. This comparison, for example, determines performance deviations.

In an example, the performance issue diagnostic module of the sprayer diagnostic controller 152 identifies the incorrect spray pattern arc through cooperation with the performance issue catalog 154, 503. If the determined performance deviations correspond with the monitored characteristics outside of thresholds or satisfying thresholds (depending on the characteristic and threshold) set for the performance issue (e.g., an incorrect spray pattern arc performance issue in this example) the performance issue is considered present. If the determined performance deviations correspond with the monitored characteristics outside of thresholds or satisfying thresholds (depending on the characteristic and threshold) set for the performance issue (e.g., an incorrect spray pattern arc nozzle performance issue in this example) the performance issue is considered present. In the present example, one or more of the determined performance deviations are indicative of an incorrect spray pattern arc. In another example, a plurality of the performance deviations for the incorrect spray pattern arc performance issue provide increased confidence the incorrect spray pattern arc performance issue is present.

An indication of an incorrect spray pattern arc, through cooperation with a diagnostic indication module via the sprayer diagnostic controller 152, provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. In an example, the remedial action is likely to alert the operator to check or replace a nozzle or a nozzle tip. In another example, the systems 150, 160 may monitor or identify provide an indication to adjust or recalibrate the nozzle tip.

An incorrect spray pattern modulation 543 (see FIG. 5A) is an example of an identified performance issue. In an example, to determine there is an incorrect spray pattern modulation, the performance deviation comparator of the sprayer diagnostic controller 152 compares the monitored spray pattern arc 513 or the monitored spray pattern modulation 517 with specified performance profile of the monitored characteristic. This comparison, for example, determines performance deviations.

In an example, the performance issue diagnostic module of the sprayer diagnostic controller 152 identifies the incorrect spray pattern modulation through cooperation with the performance issue catalog 154, 503. If the determined performance deviations correspond with the monitored characteristics outside of thresholds or satisfying thresholds (depending on the characteristic and threshold) set for the performance issue (e.g., an incorrect spray pattern modulation performance issue in this example) the performance issue is considered present. In the present example, one or more of the determined performance deviations are indicative of an incorrect spray pattern modulation. In another example, a plurality of the performance deviations for the incorrect spray pattern modulation performance issue provide increased confidence the incorrect spray pattern modulation performance issue is present.

An indication of the incorrect spray pattern modulation through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. In an example, the remedial action is likely to alert the operator to check or replace a nozzle or a nozzle tip. In another example, the systems 150, 160 may monitor or identify provide an indication to recalibrate the nozzle tip.

An incorrect boom height 551 (e.g., boom height is too high or too low) (see FIG. 5B) is an example of an identified performance issue. In an example, to determine there is an incorrect boom height, the performance deviation comparator of the sprayer diagnostic controller 152 compares the monitored spray origin 510 or the pattern overlap 516 (e.g. index location of overlap, distance from nozzle, magnitude of overlap relative to non-overlapped portion of pattern) with specified performance profile of the monitored characteristic. This comparison, for example, determines performance deviations.

In an example, the performance issue diagnostic module of the sprayer diagnostic controller 152 identifies the incorrect boom height through cooperation with the performance issue catalog 154, 503. If the determined performance deviations correspond with the monitored characteristics outside of thresholds or satisfying thresholds (depending on the characteristic and threshold) set for the performance issue (e.g., an incorrect boom height performance issue in this example) the performance issue is considered present. In the present example, one or more of the determined performance deviations are indicative of an incorrect boom height. In another example, a plurality of the performance deviations for the incorrect boom height performance issue provide increased confidence the incorrect boom height performance issue is present.

An indication of the incorrect boom height through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. In an example, the remedial action is likely to alert the operator to check or adjust the boom height. In another example, the systems 150, 160 may monitor or adjust the boom height.

A nozzle stuck in an open or closed configuration 553 (see FIG. 5B) is an example of an identified performance issue. In an example, to determine there is a nozzle stuck in an open or a closed configuration, the performance deviation comparator of the sprayer diagnostic controller 152 compares the monitored droplets (size or range of sizes) 511 or the monitored spray pattern arc 513 with specified performance profile of the monitored characteristic. This comparison, for example, determines performance deviations.

In an example, the performance issue diagnostic module of the sprayer diagnostic controller 152 identifies if the nozzle is stuck in an open or closed configuration through cooperation with the performance issue catalog 154, 503. If the determined performance deviations correspond with the monitored characteristics outside of thresholds or satisfying thresholds (depending on the characteristic and threshold) set for the performance issue (e.g., a nozzle stuck in an open or closed configuration performance issue in this example) the performance issue is considered present. In the present example, one or more of the determined performance deviations are indicative of a nozzle stuck in an open or closed configuration. In another example, a plurality of the performance deviations for nozzle stuck in an open or closed configuration performance issue provide increased confidence the nozzle stuck in an open or closed configuration performance issue is present.

An indication of the nozzle stuck in an open or closed configuration through cooperation with a diagnostic indication module via the sprayer diagnostic controller 152 provides an alert to the user or an indication of the performance issue is transmitted to the systems 150, 160 to perform a remedial action. In an example, the indication includes an associated remedial action or the remedial action is a separate, but related action. For example, the indication of the remedial action to the system 150, 160 triggers the implementation of the specified remedial action. In an example, the remedial action is likely to alert the operator to examine the nozzle or replace. In another example, the systems 150, 160 may automatically repair the nozzle.

Each of the example performance issues previously discussed can occur alone or in combination. For example, there is a misalignment of the at least one nozzle assembly 120, 220 and the spray pattern arc 442a, 442b is outside of the performance threshold. In such an example, the one or more sensors 130, 230 monitor (e.g., observes or senses) the spray origin 510 at least one nozzle assembly 120, 220 and the one or more sensors 130, 230 monitor the spray pattern arc 513. In an example, the automated diagnostic system 150, through the use of the processor 151, the performance issue catalog 154 and the sprayer diagnostic controller 152 determines the at least one nozzle assembly is misaligned 521 and the at least one nozzle assembly is plugged 531. The automated sprayer diagnostic system 150 then, as an example, indicates to the user that the orientation of the at least one nozzle assembly needs to be reoriented 521 and inspected and repaired 531.

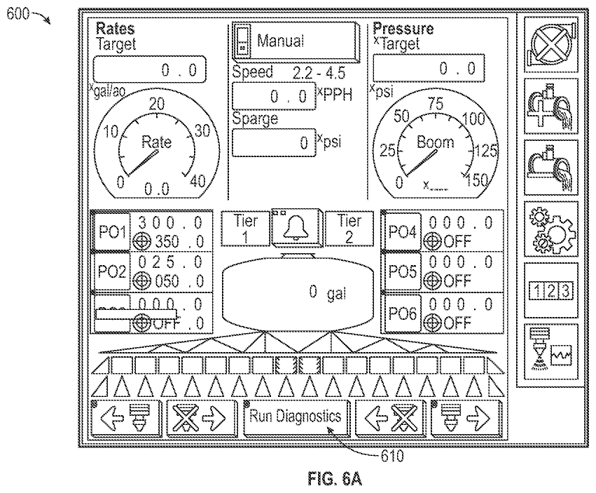

As illustrated in FIG. 6A, the automated sprayer diagnostic system 150 (as illustrated in FIG. 1) indicates, or notifies, a user of the performance issue on an operating platform 600 (e.g., screen, computer system or the like). In an example, the user runs a diagnostic test before operating the agricultural vehicle, such as the sprayer. In another example, the user runs a diagnostic test during operation of the agricultural vehicle, such as during a turn between swaths in a field. In an example, the user can activate the system 600 by pressing a button 610 or another means of activation, such as a voice command. For instance, activating the system 600 with the button 610 causes the previously discussed automated sprayer diagnostic system 150 to perform analytic operations on each of the at least one nozzle assembly 120, 220 related to FIG. 1 or FIG. 2.

In an example illustrated in FIG. 6B, the automated sprayer diagnostic system 150 (as illustrated and discussed related FIG. 1) notifies the user on a diagnostic screen 650. For instance, the diagnostic screen 650 has references 652 corresponding to each of the at least one nozzle assembly 120, 220 (as discussed related to FIGS. 1 and 2). In an example, the diagnostic screen 650 indicates a fault 654, or performance issue, by changing the color of the reference 652, flashing the reference 652 or the like of the associated reference 652. In another example, the automated sprayer diagnostic system 150 notifies the user of an intermittent performance issue 656 (e.g., some droplets are within the threshold at certain time and some droplets are outside of the threshold at other times) by changing the color of the reference 652 or flashing the reference 652.

In an example, the user is able to select the reference 652 indicated as having a performance issue. For instance, when the user selects the reference 652 the system 600 provides details regarding remedial actions, such as those discussed previously related to FIGS. 5A and 5B. In such an example, the user takes physical steps to remedy the performance issue (e.g., replacing or cleaning at least one nozzle assembly). In another example, the user directs the system 600 to automatically remedy the performance issue (e.g. altering the height of the boom or orientation of at least one nozzle assembly). In yet another example, the system 600 communicates with the operational system 160 to automatically perform remedial actions.

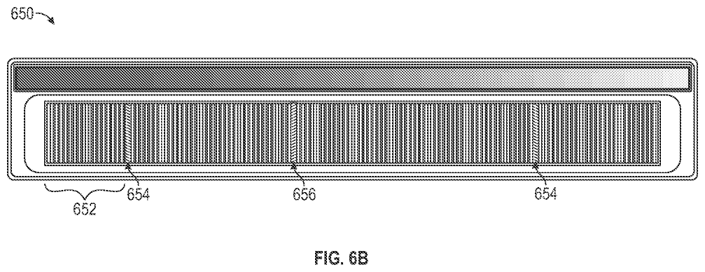

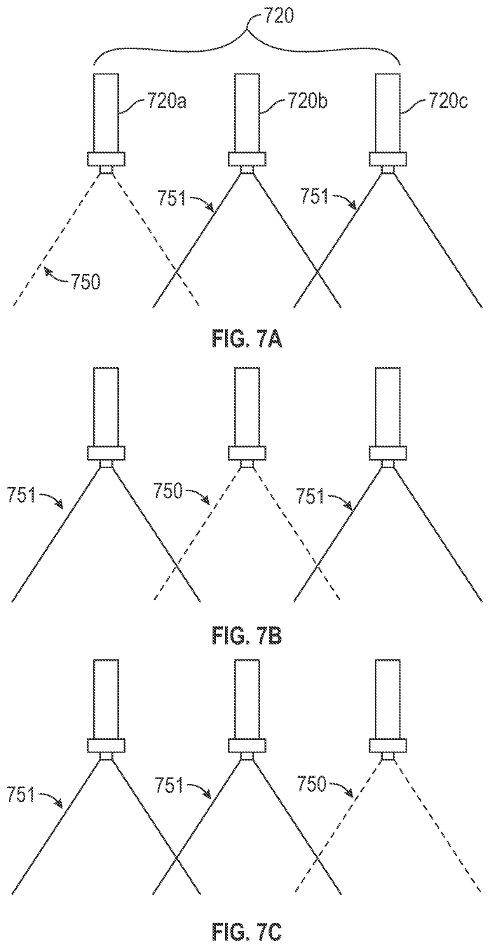

Illustrated in FIGS. 7A, 7B, 7C illustrate an example diagnostic operation in accordance with the systems, for example, described related to FIGS. 6A and 6B. In an example diagnostic test, a user or the system 150 itself initiates diagnostic test (e.g., at start up, while stationary or the like) to check for leaks in the system (532 in FIG. 5D). If leaks are present, the user or the system conducts the recommended remedial action. If there are no leaks, the operation system 160 activates the sensors 130, 230 to monitor the nozzle assemblies. For example, the user directs the system 150, operational system 160 160 to sequentially test each nozzle assembly (e.g., turn nozzle 1 on, turn nozzle 2 on, . . . turn nozzle 1 off, turn nozzle 2 off . . . ). Optionally, the diagnostic system 150, operational system 160 or the like autonomously conducts sequential testing. In another example, the user intentionally causes faults in the sprayer system (e.g. miswiring the nozzle assemblies) as a control to test the automated sprayer diagnostic system 150. In one example, the sensors 130, 230 monitor the nozzle assemblies together. In another example, the sensors 130, 230 monitor each nozzle assembly individually. In an example diagnostic test, the user activates the diagnostics (e.g., pressing the diagnostic button 610) the nozzle assemblies 720 are operated in sequence during a diagnostic scheme (as set by the automated sprayer diagnostic system 150) to assess nozzle indexing (position). As illustrated in FIG. 7A, the dashed lines 750 indicate the first nozzle assembly 720a is in an off, or deactivated, configuration and the solid lines 751 indicate the second nozzle 720b and 720c are in the on, or activated, configuration. In a next exemplary step of the diagnostic operation illustrated in FIG. 7B, the second nozzle assembly 720b is in the off or deactivated configuration and the first nozzle assembly 720a and the third nozzle assembly 720c are in the on or activated configuration. In a subsequent, exemplary, step of the diagnostic operation illustrated in FIG. 7C, the third nozzle assembly 720c is in an off, or deactivated, configuration and the first nozzle assembly 720a and the second nozzle assembly 720b are in the on, or activated, configuration.

In other examples, transitioning the nozzle assemblies 720a, 720b, 720c between off and on is conducted to assess the component nozzle assemblies are accurately or precisely following predicated duty cycles (e.g. pulse with modulation duty cycles) and thereby assess the functionality of the nozzle assemblies 720a, 720b, 720c. In still other examples, plumbing of the sprayer system is observed by the sensor 130, 230 associated with each nozzle assembly 720a, 720b, 720c, for instance to confirm section shut off, valve shut off, and turn on associated nozzle assemblies to confirm the main pump and section pumps are operating within parameters or thresholds or the like. In such an example, the automated sprayer diagnostic system 150 tests and confirms correct operation of the system such as confirming performance profiles align with performance thresholds (e.g. the spray pattern, droplet size, etc.).

### Various Notes and Aspects

Aspect 1 can include subject matter such as an automated sprayer diagnostic system comprising: at least one sensor directed toward at least one nozzle assembly of a sprayer implement, the at least one sensor configured to monitor an actual performance profile of the at least one nozzle assembly; a processor in communication with the at least one sensor; and a sprayer diagnostic controller in communication with the at least one sensor and the processor, the sprayer diagnostic controller includes in communication with the at least one sensor and the processor, the sprayer diagnostic controller includes: a performance deviation comparator configured to compare the actual performance profile of the at least one nozzle assembly with a specified performance profile and determine one or more performance deviations from the comparison; a performance issue diagnostic module configured to identify at least one performance issued based on the one or more performance deviations; and a diagnostic indication module configured to provide a diagnostic indication of the identified at least one performance issue.

Aspect 2 can include, or can optionally be combined with the subject matter of Aspect 1, to optionally include wherein the at least one sensor is coupled with a sensor boom, and the sensor boom is configured to direct the at least one sensor toward the at least one nozzle assembly.

Aspect 3 can include, or can optionally be combined with the subject matter of one or any combination of Aspects 1 or 2 to optionally include wherein the at least one nozzle assembly includes a plurality of nozzle assemblies, and the at least one sensor is coupled with a sensor actuator configured to traverse a scan line of the at least one sensor across the plurality of nozzle assemblies.

Aspect 4 can include, or can optionally be combined with the subject matter of one or any combination of Aspects 1-3 to optionally include wherein the at least one nozzle assembly includes a plurality of nozzle assemblies, the at least one sensor includes a plurality of sensors, and each sensor of the plurality of sensors is associated with respective subsets of nozzle assemblies of the plurality of nozzle assemblies.

Aspect 5 can include, or can optionally be combined with the subject matter of one or any combination of Aspects 1-4 to optionally include wherein the at least one sensor includes one or more of a camera, video camera, ultrasound sensor, laser sensor, LIDAR sensor or radar sensor.

Aspect 6 can include, or can optionally be combined with the subject matter of Aspects 1-5 to optionally include wherein the actual performance profile includes one or more performance characteristics associated with the at least one nozzle assembly including droplet characteristics, droplet modulation characteristics, spray pattern characteristics, spray pattern modulation characteristics, spray origin, pattern locality or boom height.

Aspect 7 can include, or can optionally be combined with the subject matter of Aspects 1-6 to optionally include wherein the specified performance profile includes one or more specified performance thresholds including spray origin, droplet size, droplet size range, droplet modulation, spray pattern arc, spray pattern orientation, spray pattern direction, spray pattern overlap, spray pattern modulation, pattern locality or boom height.

Aspect 8 can include, or can optionally be combined with the subject matter of Aspects 1-7 to optionally include wherein the at least one performance issue includes one or more of nozzle plugging, nozzle fouling, nozzle misalignment, nozzle position error, nozzle index error, nozzle sequence error, droplet size error, droplet size modulation error, spray pattern arc error, spray pattern modulation error, plumbing leak, plumbing blockage, boom height error, nozzle stuck open, nozzle stuck closed, incorrect nozzle installation.

Aspect 9 can include, or can optionally be combined with the subject matter of Aspects 1-8 to optionally include wherein the one or more performance deviations includes multiple performance deviations, and the performance deviation comparator is configured to determine multiple performance deviations from the comparison of the actual performance profile and the specified performance profile.

Aspect 10 can include, or can optionally be combined with the subject matter of Aspects 1-9 to optionally include a performance issue catalog including at least first and second performance issues: the first performance issue having a first threshold array of one or more threshold deviations; and the second performance issue having a second threshold array of one or more threshold deviations, the second array different than the first array.

Aspect 11 can include, or can optionally be combined with the subject matter of Aspects 1-10 to optionally include wherein the performance issue diagnostic module configured to identify the at least one performance issue includes the performance issue diagnostic module configured to conduct an array comparison of the one or more performance deviations with the one or more threshold deviations of the first and second threshold arrays, and select at least one of the first or second performance issues based on the array comparison.

Aspect 12 can include, or can optionally be combined with the subject matter of Aspects 1-11 to optionally include wherein the performance issue diagnostic module is configured to identify the at least one performance issue based on one or more of magnitudes of deviation or type of deviation.

Aspect 13 can include, or can optionally be combined with the subject matter of Aspects 1-12 to optionally include an automated spray diagnostic system comprising: at least one sensor directed toward at least one nozzle of a sprayer implement, a processor in communication with the at least one sensor including: the at least one sensor configured to monitor an actual performance profile of the at least one nozzle assembly; a performance issue catalog including at least first and second performance issues: the first performance issue having a first threshold array of one or more threshold deviations; and the second performance issue having a second threshold array of one or more threshold deviations, the second array different than the first array; and a sprayer diagnostic controller in communication with the at least one sensor, the sprayer diagnostic controller includes: a performance deviation comparator configured to conduct a profile comparison of the actual performance profile of the at least one nozzle assembly with a specified performance profile and determine one or more performance deviations from the profile comparison; a performance issue diagnostic module configured to conduct an array comparison of the one or more performance deviations with the one or more threshold deviations of the first and second threshold arrays, and select at least one of the first or second performance issues based on the array comparison; and a diagnostic indication module configured to provide a diagnostic indication of the at least one selected first or second performance issues.

Aspect 14 can include, or can optionally be combined with the subject matter of Aspects 1-13 to optionally include wherein the at least one sensor is coupled with a sensor boom, and the sensor boom is configured to direct the at least one sensor toward the at least one nozzle assembly.

Aspect 15 can include, or can optionally be combined with the subject matter of Aspects 1-14 to optionally include wherein the at least one nozzle assembly includes a plurality of nozzle assemblies, and the at least one sensor is coupled with a sensor actuator configured to traverse a scan line of the at least one sensor across the plurality of nozzle assemblies.

Aspect 16 can include, or can optionally be combined with the subject matter of Aspects 1-15 to optionally include wherein the at least one sensor includes one or more of a camera, video camera, ultrasound sensor, laser sensor, LIDAR sensor or radar sensor.

Aspect 17 can include, or can optionally be combined with the subject matter of Aspects 1-16 to optionally include wherein the actual performance profile includes one or more performance characteristics associated with the at least one nozzle assembly including droplet characteristics, droplet modulation characteristics, spray pattern characteristics, spray pattern modulation characteristics, spray origin, pattern locality or boom height.

Aspect 18 can include, or can optionally be combined with the subject matter of Aspects 1-17 to optionally include wherein the specified spray profile includes one or more specified performance thresholds including spray origin, droplet size, droplet size range, droplet modulation, spray pattern arc, spray pattern orientation, spray pattern direction, spray pattern overlap, spray pattern modulation, pattern locality or boom height.

Aspect 19 can include, or can optionally be combined with the subject matter of Aspects 1-18 to optionally include wherein the first or second performance issues include one or more of nozzle plugging, nozzle fouling, nozzle misalignment, nozzle position error, nozzle index error, nozzle sequence error, droplet size error, droplet size modulation error, spray pattern arc error, spray pattern modulation error, plumbing leak, plumbing blockage, boom height error, nozzle stuck open, nozzle stuck closed, incorrect nozzle installation.

Aspect 20 can include, or can optionally be combined with the subject matter of Aspects 1-19 to optionally include wherein the performance issue diagnostic module is configured to compare one or more of magnitudes of deviation or types of deviation of the one or more performance deviations with the one or more threshold deviations of the first and second threshold arrays.

Aspect 21 can include, or can optionally be combined with the subject matter of Aspects 1-20 to optionally include wherein one or more threshold deviations of at least one of the first or second threshold arrays include one or more of magnitude of deviation thresholds or types of deviation thresholds.

Aspect 22 can include, or can optionally be combined with the subject matter of Aspects 1-21 to optionally include wherein the performance issue diagnostic module is configured to select either of the first or second performance issues based on degrees of correspondence between the one or more performance deviations and the respective one or more threshold deviations of the first and second performance issues.

Aspect 23 can include, or can optionally be combined with the subject matter of Aspects 1-22 to optionally include wherein the degree of correspondence includes a first difference between the one or more performance deviations and the one or more threshold deviations of the first threshold array and a second difference between the one or more performance deviations and the one or more threshold deviations of the second threshold array; and the performance issue diagnostic module is configured to select the first or second performance issue based on the smaller of the first and second differences.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part. Some aspects or examples can include a computer-readable medium or machine-readable medium encoded with instructions operable to configure an electronic device to perform methods as described in the above aspects or examples. An implementation of such methods can include code, such as microcode, assembly language code, a higher-level language code, or the like. Such code can include computer readable instructions for performing various methods. The code may form portions of computer program products. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. An automated sprayer diagnostic system comprising:
at least one sensor directed toward at least one nozzle assembly of a sprayer implement, the at least one sensor configured to monitor an actual performance profile of the at least one nozzle assembly;
a processor in communication with the at least one sensor; and
a sprayer diagnostic controller in communication with the at least one sensor and the processor, the sprayer diagnostic controller includes:
a performance deviation comparator configured to compare the actual performance profile of the at least one nozzle assembly with a specified performance profile and determine one or more performance deviations from the comparison;
a performance issue diagnostic module configured to identify at least one performance issued based on the one or more performance deviations; and
a diagnostic indication module configured to provide a diagnostic indication of the identified at least one performance issue.

2. The automated sprayer diagnostic system of claim 1, wherein the at least one sensor is coupled with a sensor boom, and the sensor boom is configured to direct the at least one sensor toward the at least one nozzle assembly.

3. The automated sprayer diagnostic system of claim 1, wherein the at least one nozzle assembly includes a plurality of nozzle assemblies, and the at least one sensor is coupled with a sensor actuator configured to traverse a scan line of the at least one sensor across the plurality of nozzle assemblies.

4. The automated sprayer diagnostic system of claim 1, wherein the at least one nozzle assembly includes a plurality of nozzle assemblies, the at least one sensor includes a plurality of sensors, and each sensor of the plurality of sensors is associated with respective subsets of nozzle assemblies of the plurality of nozzle assemblies.

5. The automated sprayer diagnostic system of claim 1, wherein the at least one sensor includes one or more of a camera, video camera, ultrasound sensor, laser sensor, LIDAR sensor or radar sensor.

6. The automated sprayer diagnostic system of claim 1, wherein the actual performance profile includes one or more performance characteristics associated with the at least one nozzle assembly including droplet characteristics, droplet modulation characteristics, spray pattern characteristics, spray pattern modulation characteristics, spray origin, pattern locality or boom height.

7. The automated sprayer diagnostic system of claim 1, wherein the specified performance profile includes one or more specified performance thresholds including spray origin, droplet size, droplet size range, droplet modulation, spray pattern arc, spray pattern orientation, spray pattern direction, spray pattern overlap, spray pattern modulation, pattern locality, or boom height.

8. The automated sprayer diagnostic system of claim 1, wherein the at least one performance issue includes one or more of nozzle plugging, nozzle fouling, nozzle misalignment, nozzle position error, nozzle index error, nozzle sequence error, droplet size error, droplet size modulation error, spray pattern arc error, spray pattern modulation error, plumbing leak, plumbing blockage, boom height error, nozzle stuck open, nozzle stuck closed, incorrect nozzle installation.

9. The automated sprayer diagnostic system of claim 1, wherein the one or more performance deviations includes multiple performance deviations, and the performance deviation comparator is configured to determine multiple performance deviations from the comparison of the actual performance profile and the specified performance profile.

10. The automated sprayer diagnostic system of claim 9 comprising:
a performance issue catalog including at least first and second performance issues:
the first performance issue having a first threshold array of one or more threshold deviations; and
the second performance issue having a second threshold array of one or more threshold deviations, the second array different than the first array.

11. The automated sprayer diagnostic system of claim 10, wherein the performance issue diagnostic module configured to identify the at least one performance issue includes the performance issue diagnostic module configured to conduct an array comparison of the one or more performance deviations with the one or more threshold deviations of the first and second threshold arrays, and select at least one of the first or second performance issues based on the array comparison.

12. The automated sprayer diagnostic system of claim 1, wherein the performance issue diagnostic module is configured to identify the at least one performance issue based on one or more of magnitudes of deviation or type of deviation.

13. An automated sprayer diagnostic system comprising:
at least one sensor directed toward at least one nozzle assembly of a sprayer implement, the at least one sensor configured to monitor an actual performance profile of the at least one nozzle assembly;
a processor in communication with the at least one sensor including:
a performance issue catalog including at least first and second performance issues:
the first performance issue having a first threshold array of one or more threshold deviations; and
the second performance issue having a second threshold array of one or more threshold deviations, the second array different than the first array; and
a sprayer diagnostic controller in communication with the at least one sensor, the sprayer diagnostic controller includes:
a performance deviation comparator configured to conduct a profile comparison of the actual performance profile of the at least one nozzle assembly with a specified performance profile and determine one or more performance deviations from the profile comparison;
a performance issue diagnostic module configured to conduct an array comparison of the one or more performance deviations with the one or more threshold deviations of the first and second threshold arrays, and select at least one of the first or second performance issues based on the array comparison; and
a diagnostic indication module configured to provide a diagnostic indication of the at least one selected first or second performance issues.

14. The automated sprayer diagnostic system of claim 13, wherein the at least one sensor is coupled with a sensor boom, and the sensor boom is configured to direct the at least one sensor toward the at least one nozzle assembly.

15. The automated sprayer diagnostic system of claim 13, wherein the at least one nozzle assembly includes a plurality of nozzle assemblies, and the at least one sensor is coupled with a sensor actuator configured to traverse a scan line of the at least one sensor across the plurality of nozzle assemblies.

16. The automated sprayer diagnostic system of claim 13, wherein the at least one sensor includes one or more of a camera, video camera, ultrasound sensor, laser sensor, LIDAR sensor or radar sensor.

17. The automated sprayer diagnostic system of claim 13, wherein the actual performance profile includes one or more performance characteristics associated with the at least one nozzle assembly including droplet characteristics, droplet modulation characteristics, spray pattern characteristics, spray pattern modulation characteristics, spray origin, pattern locality, or boom height.

18. The automated sprayer diagnostic system of claim 13, wherein the specified performance profile includes one or more specified performance thresholds including spray origin, droplet size, droplet size range, droplet modulation, spray pattern arc, spray pattern orientation, spray pattern direction, spray pattern overlap, spray pattern modulation, pattern locality, or boom height.

19. The automated sprayer diagnostic system of claim 13, wherein the first or second performance issues include one or more of nozzle plugging, nozzle fouling, nozzle misalignment, nozzle position error, nozzle index error, nozzle sequence error, droplet size error, droplet size modulation error, spray pattern arc error, spray pattern modulation error, plumbing leak, plumbing blockage, boom height error, nozzle stuck open, nozzle stuck closed, incorrect nozzle installation.

20. The automated sprayer diagnostic system of claim 13, wherein the performance issue diagnostic module is configured to compare one or more of magnitudes of deviation or types of deviation of the one or more performance deviations with the one or more threshold deviations of the first and second threshold arrays.

21. The automated sprayer diagnostic system of claim 20, wherein one or more threshold deviations of at least one of the first or second threshold arrays include one or more of magnitude of deviation thresholds or types of deviation thresholds.

22. The automated sprayer diagnostic system of claim 13, wherein the performance issue diagnostic module is configured to select either of the first or second performance issues based on degrees of correspondence between the one or more performance deviations and the respective one or more threshold deviations of the first and second performance issues.

23. The automated sprayer diagnostic system of claim 22, wherein the degree of correspondence includes a first difference between the one or more performance deviations and the one or more threshold deviations of the first threshold array and a second difference between the one or more performance deviations and the one or more threshold deviations of the second threshold array; and
the performance issue diagnostic module is configured to select the first or second performance issue based on a smaller of the first and second differences.
